(19) United States
(12) Patent Application Publication
(10) Pub. No.: US 2018/0194327 A1
(43) Pub. Date: Jul. 12, 2018

(54) DEVICE TO ALLOW REPLACEMENT OF WINDSHIELD WIPER INSERT

(71) Applicant: Gregory Joseph Johnson, SAVAGE, MN (US)

(72) Inventor: Gregory Joseph Johnson, SAVAGE, MN (US)

(21) Appl. No.: 15/867,565

(22) Filed: Jan. 10, 2018

Related U.S. Application Data
(60) Provisional application No. 62/444,444, filed on Jan. 10, 2017.

(51) Int. Cl. B60S 1/38

(52) U.S. Cl. CPC B60S 1/3886

(57) ABSTRACT

The presently disclosed subject matter relates generally to an end cap device which facilitates efficient replacement of windshield wiper insert. The end cap device comprises an end cap housing and a gate which can be opened or closed by the user. When the gate is opened a wiper insert can be easily removed and/or replaced. Additionally, the present disclosure provides a device that presses against wiper insert to secure it to the wiper blade and a device that changes wiper blade curvature. Specifically, the presently disclosure provides means of efficient installation, use, and replacement of wiper blade insert.

### TECHNICAL FIELD

The presently disclosed subject matter relates generally to an end cap device which facilitates efficient replacement of windshield wiper insert. Specifically, the presently disclosed end cap device makes the replacement of the wiper insert simple and minimizes materials discarded.

### BACKGROUND

The presently disclosed subject matter relates to a wiper blade, and specifically to making the replacement of the wiper insert simple and minimize materials discarded. Wiper blades are a piece of safety equipment on vehicles that after time have degraded performance, primarily due to deterioration of the wiper insert. Many wiper blades do not allow the wiper insert to be replaced by design (examples are the wiper insert is glued in, or end cap blocks wiper insert from being removed). For these reasons, most wiper blade users discard the entire wiper blade when only the wiper insert has truly deteriorated and is in need of replacement. Replacing the wiper blade is more financially costly for the user and has a negative environmental impact. In the same way, because wiper blades are usually replaced all as one piece and are costly, some users operate their wiper blades beyond acceptable performance, leading to unsafe driving conditions.

There are primarily three types of wiper blades: framed (a.k.a. conventional), frameless (a.k.a. beam or bracketless or flat), and hybrid. All wiper blade types use a resilient compound such as natural or synthetic rubber for the wiper insert (a.k.a. squeegee, refill), which component is in contact with the vehicle windshield and serves to clean the windshield by wiping obstructions. A framed wiper blade has articulating brackets which hold the wiper insert at only a number of locations. The frameless wiper blade commonly has one or two flat springs that have a natural curvature and secured to the springs by various methods is the wiper insert, in this way there are not discrete points along the wiper blade that have increased pressure, such as occurs with the framed wiper blade. At the end of the frameless wiper blade are end caps, which serve several functions which commonly include: holding the springs at a proper distance apart, keeping the wind deflector on the wiper blade, and blocking the wiper insert from withdrawing from the wiper blade. A hybrid wiper blade has frame similar to the framed wiper blade, but it generally less tall and is covered so that ice can't make the articulating joints freeze.

The following patents are only applicable to framed wiper blades: U.S. Pat. No. 6,119,302; U.S. Pat. No. 6,112,365; U.S. Pat. No. 3,823,437; U.S. Pat. No. 3,103,687; and U.S. Pat. No. 5,862,567. The devices described in this document are primarily applicable to frameless wiper blades.

The Wiper blade end cap shown in German patent number 3,842,586 uses a longitudinal gate with a living hinge. Due to the location of the hinge, it will be subject to direct sunlight and will degrade comparatively fast. Secondly, the method of latching is effective because as force is applied to the gate, the latching mechanism increases in strength. However, the operation of the gate is not intuitive, and users may inadvertently pull on the gate to open it, when it needs to be pressed on and up to unlatch and open. This could lead to user injury or damage of the gate and end cap. Lastly, the device element the inventor called a “bit” is difficult to manufacture through injection molding processes due to the location of the “lever” (in this disclosure named the gate) during the molding process.

Another method of allowing wiper inserts to be replaced is described in U.S. Pat. No. 6,119,302 and uses a stop called an “End Piece” that is located at the end of the wiper blade and rotates about a hinge pin. When the end piece is in the down position, it blocks longitudinal movement of the wiper insert. When the end piece is rotated to the up position, the wiper insert is free to be removed and replaced. The end piece can be locked in the down position by locking projections and associated recesses. When rotated, the projections move 180° and enter the opposite recess. The recesses, if made large and robust, will cause excessive force between the locking projection and the wiper blade, which will lead to rapid wear and possibly high force required to operate the end piece. If the locking projections are small, then minor manufacturing variations, will lead to some of the locking projections not operating at all. If the end piece is not locked in the down position, the wiper insert is able to move and possibly fall from the wiper blade altogether. In addition, this device is designed for framed wiper blades. It can't be immediately moved to modern bracketless (beam) wiper blades because a new structure would need to be added to receive and secure the hinge pin, which will allow the end piece to operate as intended. This will require additional parts and increase the cost of the wiper blade.

Another method for securing the wiper insert to the wiper blade is described in U.S. Pat. No. 8,745,813. This device requires a specialized wiper insert (thickened portion, additional rubber material, additional faces) or additional component (metal clip, staple) at the end of the wiper insert, near the specialized end cap. This extra rubber or added clip, serves to interact with the end cap to secure the wiper insert. When a lever or gate on the end cap is opened, the wiper insert can then be removed and replaced. The end cap device disclosed herein can utilize a wiper insert that is uniform throughout, meaning nothing additional needs to be molded or secured to the end of the wiper insert for proper operation.

Another method for securing the wiper insert to the wiper blade is described in U.S. Pat. No. 6,112,365. This device is only for framed wiper blades and uses a clamp to link the wiper blade frame and the wiper insert. The clamp is deformed (pressed or pulled slightly) to allow the clamp to be removed. With the clamp removed, the backing strip (metal strip holding the wiper insert) and the wiper refill (wiper strip) can be removed from the wiper blade. The clamp could be lost when it is not secured to the wiper insert. The backing strip adds cost to the wiper insert replacement. The end cap device of this disclosure (combined with the frameless wiper blade) doesn't use a backing strip (the wiper blade springs usually serve this purpose) or a wiper insert clamp and allows the wiper insert to be replaced alone (no backing strip replaced).

Another method for securing the wiper insert to the wiper blade is described in U.S. Pat. No. 3,823,437 which is only for framed wiper blades. The wiper insert is held by metal strips, which have holes near the end that a metal clip passes through. The metal strips are held apart by a transverse member. The metal clip has bends as needed so it can secure to the frame of the wiper blade. The wiper insert is held between the metal strips, so with the clip installed, the wiper insert can't be separated from the metal strips. To replace the wiper insert, the user disengages the metal clip from the wiper blade and discards the wiper strip, the metal strips, the transverse members, and the clips. The presently disclosed end cap device works for frameless (beam, bracketless) wiper blades and allows the user to replace only the wiper insert, without replacing other parts.

Another method for securing the wiper insert to the wiper blade is described in U.S. Pat. No. 3,103,687 which blocks the wiper insert from longitudinal movement by means of a rotating cap at the wiper blade end. The device is for framed wiper blades. Holes on the side of the cap engage with dimples of the wiper blade frame to latch the cap in the down position, which serves to block and secure the wiper insert in the wiper blade. The hole and dimple latching method will be prone to manufacturing variability, which can cause the cap to be difficult to operate or alternatively open too easily, leading to an unsecured wiper insert. The end cap device described herein works for frameless wiper blades and has an improved latching mechanism which increases in strength when pressed on by the wiper insert.

Another method for securing the wiper insert to the wiper blade is described in U.S. Pat. No. 5,862,567. The device is only for framed wiper blade. In the end cap, a locking member pivots or is pressed and released between two positions, and in the lowered position part of the protrusion of the locking member passes through a hole in the wiper insert holder and blocks the wiper insert from longitudinal movement. The wiper insert can be removed and replaced without replacing other components. The device requires the protrusion of the locking member to be comparatively small to fit through the hole of the wiper insert holder and so will be prone to damage and wear. Part of the protrusion is a locking mechanism, which may further decrease the strength of the protrusion by reducing the cross section of the protrusion. Similarly, the wiper insert holder must be manufactured to very tight specifications to cause protrusion to align with the hole in the wiper insert holder. If the protrusion were to be misaligned, the protrusion would be damaged and the wiper insert would not be secured. Lastly, the latching means employed is poorly explained, and in practice may have weaknesses during normal use, operation or manufacturing such as rapid wear, difficulty in opening, inadequate latching strength, prone to protrusion misalignment leading to component damage that may be known or unknown by the user. The presently disclosed end cap device has a robust latching method that will be easy to understand by the user and works on frameless (beam, bracketless) wiper blades.

Another method for securing the wiper insert to the wiper blade is described in U.S. Pat. No. 8,402,593 in which the wiper insert is removed from the bottom of the wiper blade through recesses in the wiper blade springs that form an aperture that is large enough for the wiper insert to be guided through for removal and replacement. The device requires a special wiper blade with springs with said recesses. The user may need to either turn over wiper blade or bend down to look at the aperture to allow the wiper insert to be compressed back into the wiper blade, until it is passed the aperture, then guided through the aperture. During cold weather, it will be difficult to compress the wiper insert. If it isn't difficult, then the wiper insert is too short, and may inadvertently make its way through the aperture. The presently disclosed end cap device does not require the wiper blade spring to have recesses as needed to create an aperture for the installation or removal of the wiper insert.

In conclusion, the end cap disclosed herein has a robust latching mechanism that engages more with longitudinal force (i.e. the wiper insert impacting the gate), is not prone to hinge degradation, is intuitive for the user to operate, and allows the wiper insert to be uniform throughout and replaced without other components being also discarded.

In addition to the end cap device, the present disclosure provides two related devices: a device that presses against wiper insert to secure it to the wiper blade and a device that changes wiper blade curvature. Thus, the disclosed subject matter provides devices and methods thereof for installation, removal, replacement and use of wiper inserts.

### SUMMARY

In accordance with the present invention, various embodiments of end cap device (also termed herein “wiper blade end cap”, “wiper blade end cap device”, “end cap” and “end cap device”) and methods of use thereof are disclosed. In one embodiment, the present disclosure provides a wiper blade end cap device for securing a wiper insert comprising: an end cap housing attachable to the wiper blade and a gate attachable to said end cap housing, wherein the gate can be in at least a closed and open position: and wherein said gate in a closed position blocks the longitudinal movement of the wiper insert, and said gate in an open position facilitate the removal and replacement of a wiper insert.

In some embodiments of the end cap, the gate is attached to the end cap housing by a hinge.

In some embodiments of the end cap, the hinge is located at the front and distal end of the end cap and is oriented so that the hinge axis is vertical and gate latching is caused by the interaction of a gate latch at the end of the side of the gate and a complementary latch edge on the back of the end cap housing.

In some embodiments of the end cap, the type of hinge is selected from a group comprising of the living hinge type, the snap fit type and pin joint.

In some embodiments of the end cap, the part or all of the hinge is coated with a protective coating.

In some embodiments of the end cap, the hinge is of the living hinge type, and wherein a hinge bulwark serves to increase the radius of the hinge when the gate is in the closed position.

In some embodiments of the end cap, the hinge bulwark has a surface area that reduces sticking between the hinge surface and the hinge bulwark surface and yet provides enough surface area that the hinge is not cut or otherwise damaged by contact with the hinge bulwark.

In some embodiments of the end cap, the gate latch has an acute latch edge angle and the latch edge has a complementary angle.

In some embodiments of the end cap, a gate edge shield is located on the end cap housing.

In some embodiments of the end cap, the hinge coating is applied when the gate is between the closed position and open position of the gate.

In some embodiments of the end cap, the gate is made of elastic material.

In some embodiments of the end cap, the gate's elastic material comprises UV inhibitors.

In some embodiments of the end cap, the elastic gate is adhered to the end cap housing.

In some embodiments of the end cap, the elastic gate is joined to the end cap housing by use of a multi-shot injection molding method.

In other embodiments the present disclosure provides a device for securing a wiper insert comprising: a cutout and a center link stud, wherein said stud is attachable to a wiper blade; and, at least one open end cap.

In yet other embodiments the present disclosure provides a device for securing a wiper insert comprising: a center block comprising a center block cutout located between the top strip and the center link stud, wherein said stud is attachable to a wiper blade; and at least one open end cap.

In some embodiments of the device for securing a wiper insert, the center link stud can be in a position wherein said stud presses against the wiper insert or in a position wherein said stud does not press against the wiper insert.

In some embodiments of the device for securing a wiper insert, the center link stud is an element of the wiper arm link.

In some embodiments of the device for securing a wiper insert, the center link stud decreases in cross section distally from the wiper arm.

In some embodiments of the device for securing a wiper insert, the center link stud is angled relative to the wiper blade to provide a springing action relative to the wiper insert.

In some embodiments of the device for securing a wiper insert, the center link stud is an element of an element selected from a group comprising the open end cap, end cap, standard end cap, wind deflector or center block, and said center link stud latches when pressing against the wiper insert.

In some embodiments of the device for securing a wiper insert, the wiper insert can be removed or replaced through the open end cap when the center link stud is in a position wherein said stud does not press against the wiper insert.

In yet other embodiments, the present disclosure provides a device for changing a wiper blade curvature comprising: a wiper blade with one or more springs, a first pillar secured to the spring(s) wherein said first pillar secures a screw and directed toward a second pillar, said second pillar wherein said second pillar is secured to the wiper blade springs and has a threaded member that engages said screw, and wherein the rotation of said screw alters the curvature of the wiper blade.

In some embodiments of the device for changing a wiper blade curvature, the screw is able to pivot in the first pillar.

In some embodiments of the device for changing a wiper blade curvature, the threaded member on the second pillar able to pivot.

In some embodiments of the device for changing a wiper blade curvature, said device comprises a lever attached to the screw.

In some embodiments of the device for changing a wiper blade curvature, said device comprises a means to latch the screw.

In some embodiments of the device for changing a wiper blade curvature, the second pillar is on the side of the center block with the wiper arm.

In yet other embodiments, the present disclosure provides a device for changing a wiper blade curvature which comprises: a wiper blade with one or more springs, a first pillar secured to said spring(s) wherein said first pillar secures a tether and said tether is directed toward a second pillar, said second pillar wherein said second pillar is secured to said spring(s) and comprises means to secure the tether from movement, and wherein a change in the length of said tether between the first pillar and second pillar alters the curvature of the wiper blade.

In some embodiments of the device for changing a wiper blade curvature, said device comprises latching cavities on the tether and latching protrusions as elements of the pillar tether securing means or the second pillar.

In some embodiments of the device for changing a wiper blade curvature, said device comprises latching protrusions on the tether and latching cavities as elements of the pillar tether securing means or the second pillar.

In some embodiments of the device for changing a wiper blade curvature, the first pillar and the second pillar as part of a center block.

In some embodiments of the device for changing a wiper blade curvature, the first pillar and the second pillar are part of a center block and the spring(s) are secured to the center block at approximately the mid-point of the center block base.

In some embodiments of the device for changing a wiper blade curvature, the pillar tether securing means comprise one or more cleat members that the tether is directed through, and the tether is held between two cleat members or between one cleat member and the pillar tether securing mean or a surface of the second pillar.

In some embodiments of the device for changing a wiper blade curvature, there is a cleat member lever on the cleat member.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a perspective view of the presently disclosed end cap, wherein the end cap is attached to a wiper blade.

FIG. 2 is a perspective view of the presently disclosed end cap, wherein the end cap is attached to a wiper blade and the gate is in a closed position.

FIG. 3 is a perspective view of the presently disclosed end cap, wherein the end cap is attached to a wiper blade and the gate is in an opened position.

FIG. 4 is a perspective view of an embodiment of the presently disclosed end cap, wherein the end cap is attached to a wiper blade and the gate is in an opened position.

FIG. 5 is a perspective bottom view of an embodiment of the presently disclosed end cap, wherein the end cap is attached to a wiper blade and the gate is in an opened position.

FIG. 6 is a perspective view of an embodiment of the presently disclosed end cap, wherein the end cap is attached to a wiper blade and the gate is in an opened position.

FIG. 7 is a perspective view of an embodiment of the presently disclosed end cap, wherein the end cap is attached to a wiper blade and the gate is in an opened position.

FIG. 8 is a perspective bottom view of an embodiment of the presently disclosed end cap, wherein the end cap is attached to a wiper blade and the gate is in a closed position.

FIG. 9 is an exploded bottom view of an embodiment of the presently disclosed end cap, wherein the end cap is attached to a wiper blade and the gate is in an opened position.

FIG. 10 is a perspective bottom view of an embodiment of the presently disclosed end cap, wherein the end cap is attached to a wiper blade and the gate is in a closed position.

FIG. 11 is a perspective bottom view of an embodiment of the presently disclosed end cap, wherein the end cap is attached to a wiper blade and the gate is in a closed position.

FIG. 12 is a perspective bottom view of an embodiment of the presently disclosed end cap, wherein the end cap is attached to a wiper blade and the gate is in an opened position.

FIG. 13 is a perspective bottom view of an embodiment of the presently disclosed end cap, wherein the end cap is attached to a wiper blade and the gate is in an opened position.

FIG. 14 is a partial bottom view of an embodiment of the presently disclosed end cap, wherein the end cap is attached to a wiper blade and the gate is in an opened position.

FIG. 15 is a perspective bottom view of an embodiment of the presently disclosed end cap, wherein the end cap is attached to a wiper blade and the gate is in a closed position.

FIG. 16 is a perspective bottom view of an embodiment of the presently disclosed end cap, wherein the end cap is attached to a wiper blade and the gate is in an opened position.

FIG. 17 is a exploded view of an embodiment of the presently disclosed end cap.

FIG. 18 is a perspective view of an embodiment of the presently disclosed end cap, wherein the end cap is attached to a wiper blade and the gate is in a closed position.

FIG. 19 is a sectional view of the device that presses against wiper insert to secure it to the wiper blade wherein the device is attached to the wiper blade.

FIG. 20 is a bottom sectional view of the device that presses against wiper insert to secure it to the wiper blade wherein the device is attached to the wiper blade.

FIG. 21 is a sectional view of an embodiment of the device that presses against wiper insert to secure it to the wiper blade.

FIG. 22 is a sectional view of an embodiment of the device that presses against wiper insert to secure it to the wiper blade.

FIG. 23 is a sectional view of an embodiment of the device that presses against wiper insert to secure it to the wiper blade.

FIG. 24 is a sectional view of an embodiment of the device that presses against wiper insert to secure it to the wiper blade.

FIG. 25 is a sectional view of the device that presses against wiper insert to secure it to the wiper blade wherein the device is attached to the wiper blade.

FIG. 26 is a perspective view of the presently disclosed end cap, wherein the gate is in a closed position.

FIG. 27 is a perspective view of the presently disclosed end cap, wherein the gate is in an opened position.

FIG. 28 is a perspective view of the device that presses against wiper insert to secure it to the wiper blade wherein the device is attached to the wiper blade.

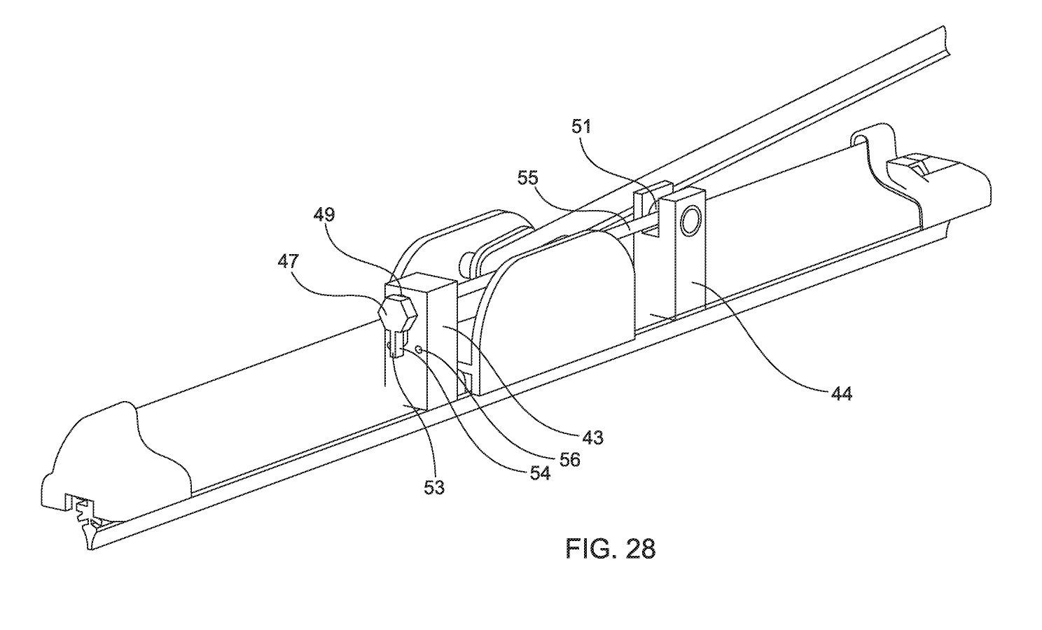

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The presently disclosed subject matter provides an end cap device which enables an easy replacement of a wiper insert while minimizing materials discarded

In some embodiments, the presently disclosed subject matter provides an end cap device that that secure wiper insert by blocking.

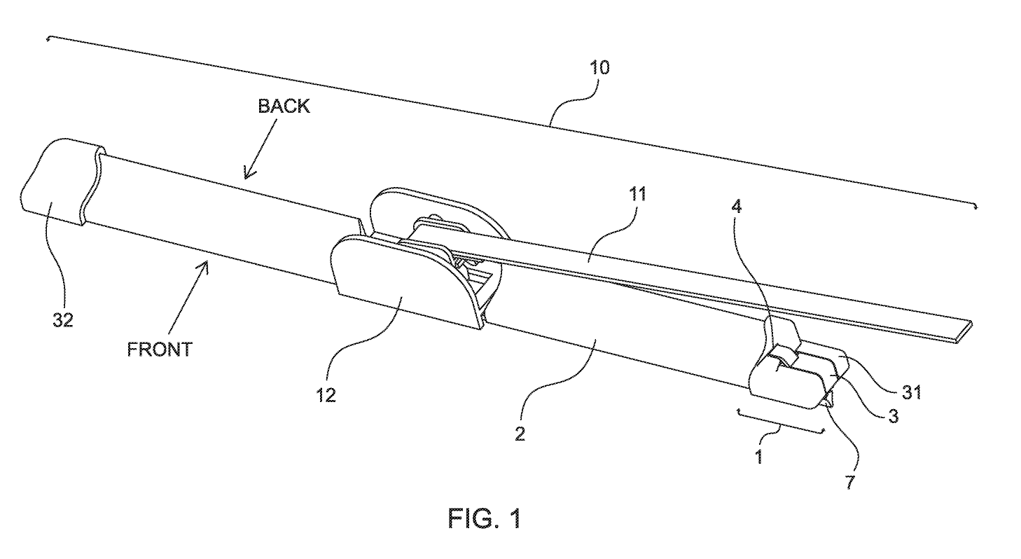

Referring now to FIG. 1, an embodiment of an end cap attached to a wiper blade is illustrated. The wiper blade shown is a frameless wiper blade 10 which comprises a wiper insert 7, wind deflector 2, center block 12, a standard end cap 32, and the presently disclosed end cap 1. The presently disclosed end cap 1 comprises end cap housing 31, the gate 3, and the gate hinge 4. The wiper blade 10 is connected to the vehicle by the wiper arm 11. The center block 12 forms the link between the wiper arm 11 and the wiper blade 10. In normal use, the wiper arm 11 is operated by the vehicle in such a way that the wiper blade 10 is rotated to enable windshield cleaning.

The standard end cap 32 has these primary purposes:
to stay secured to the wiper blade 10
to hold the wind deflector 2 in place
and to block the wiper insert 7 from falling out of the wiper blade 10.

Many frameless wiper blade designs have two flat springs 6 (not shown in FIG. 1), which serve as the frame, and these springs 6 can be joined as one piece near the standard end cap 32 or they can be left as separate springs 6, in the case of separate springs 6, the standard end cap 32 holds the wiper blade springs 6 at a proper distance of separation and approximately planar. End cap 1 perform all necessary functions of the standard end cap 32, however additionally it can be in one of two positions: in one position it blocks the wiper insert 7, and in a second positions where it does not block (these positions of the end cap 1 and their embodiments will be further described below). When in the second position the wiper insert 7 can be easily removed and replaced, which would allow more cost-effective use of the wiper blade system on a vehicle, because wiper inserts 7 can be made less expensively than an entire new wiper blade 10.

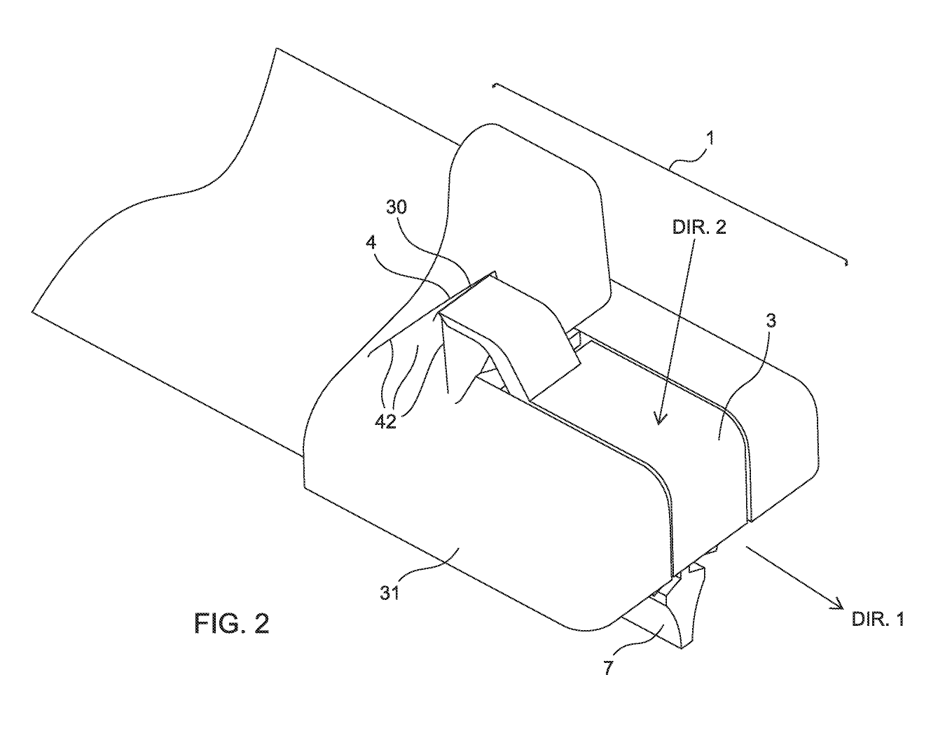

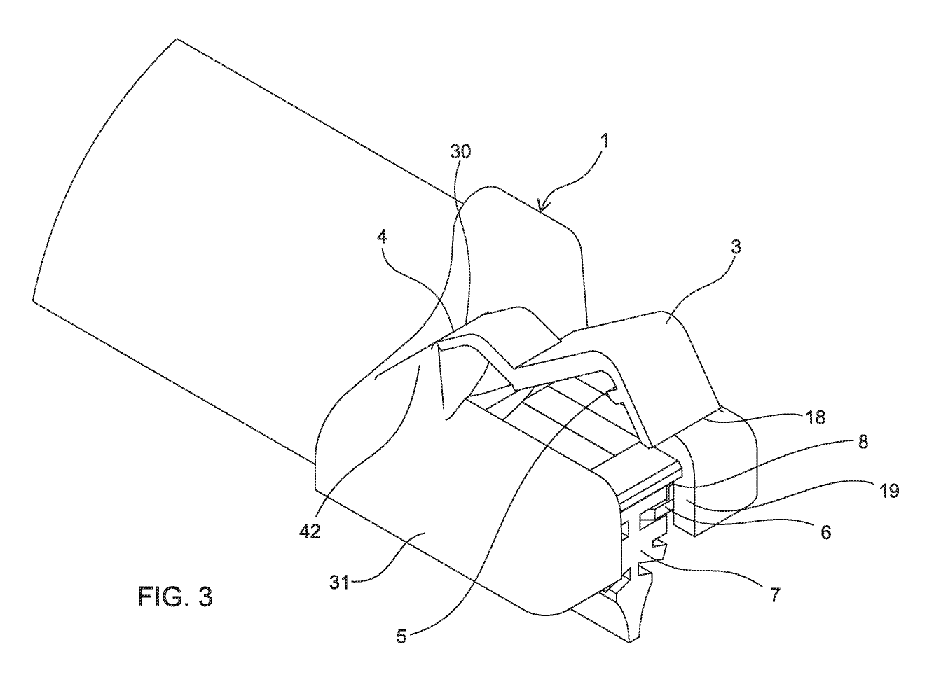

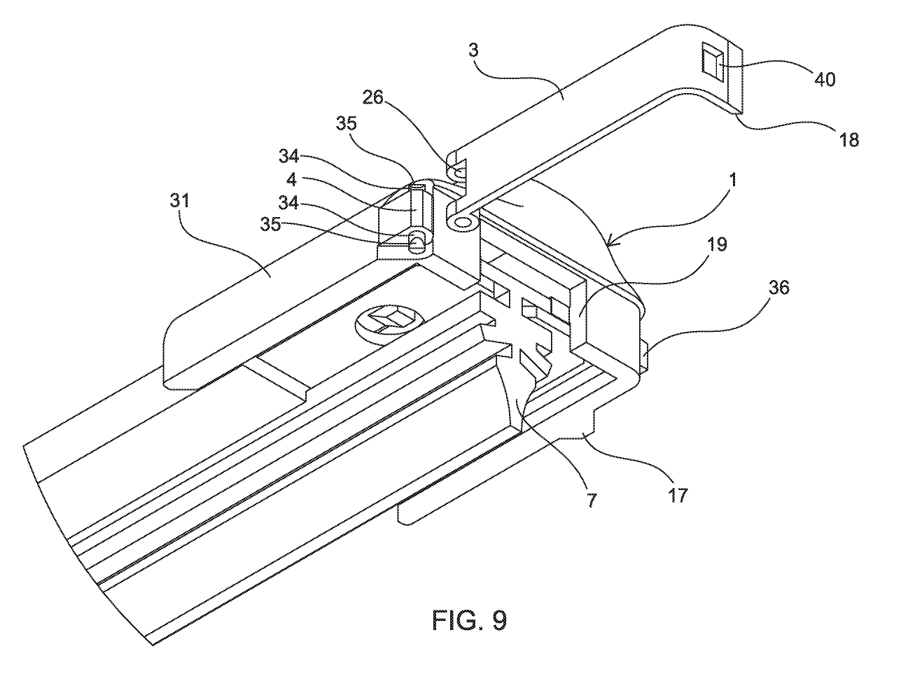

In some embodiments, the end cap 1 comprises a gate 3 that has two positions, the first position being the closed position as shown in FIG. 1 which blocks the wiper insert 7 from shifting out of its secured position inside the wiper blade. In some embodiments, the end cap 1 comprises a form of latching that secures the gate 3 in the closed position (shown at least in FIGS. 1 and 2). The other position of the gate 3 is the open position, which is shown in at least FIG. 3. The wiper insert 7 is free to slide longitudinally when the gate 3 is in the open position and so be removed and replaced. The longitudinal direction being the direction of the largest dimension of the wiper blade 10. In some embodiments, the end cap 1 comprises a gate hinge 4 that secures the gate 3 to the end cap housing 31. Various forms of hinging mechanisms can be used including, but not limited to, revolute hinges that are of the forms: living hinge, snap fit hinge, and pin joint. A living hinge (A.K.A. integral hinge) is a thin flexible web made from the same material as the two relatively rigid pieces it connects and it allows the two joined sections to bend along the line of the hinge web. Therefore, a simple living hinge is a thin layer joining two rigid parts, and the two rigid parts can hinge relative to each other by bending the thin layer in a hinging fashion that is joining them, see FIG. 2 for an example. A snap fit hinge has the two joining parts to be produced separately and then they are assembled together. The snap fit joint will deflect and then snap into place. For the purpose of the end cap 1, the snap fit joint would operate as a cantilever snap joint and at the center of the joining faces is a hinge protrusion 34 and on the mating surface a cavity that receives the hinge protrusion 34 (this embodiment is shown in at least FIG. 9). According to the present disclosure the said cavity is named the hinge joint 26. Once the joint is snapped into place, the gate 3 will pivot about the hinge protrusion 34 of the snap fit joint. The hinge protrusion 34 can be either on the end cap housing 31 (as shown in FIG. 9), or on the gate 3 and the hinge joint 26 (the cavity) must then be on the opposite part. A third hinge method is a pin joint, which has a hole for a pin in the items to be joined. During assembly, the holes of the items are aligned and then the pin (A.K.A axel or shaft) is inserted through all components. Commonly, some or all of the holes are of a smaller diameter than the pin to form an interference fit and cause the pin to remain in place.

In some embodiments, the primary properties or objectives of the end cap 1 are:
it has two positions, one where the wiper insert 7 is blocked from being removed from the wiper blade, and one where the wiper insert 7 is not blocked
to enable the possibility that parts other than the wiper insert 7 itself are not removed from the wiper blade 10 during the wiper insert 7 removal and replacement process
the wiper insert 7 does not require special features like staples, protrusions, thickened portions, or recesses anywhere along the length of the wiper insert 7
the operation of the gate 3 is intuitive
the end cap 1 is preferably robust enough to withstand years of normal use

The end cap 1 and end cap housing 31 and protrusions and cavities can be made of various deformable or non-deformable materials including thermoplastics, stainless steel, or aluminum. The gate 3 and gate hinge 4 and integral elements can be made of various deformable materials including thermoplastics. The hinge coating 30, shown in at least FIG. 2, preferably has elasticity which has elongation greater than 15% before yield or plastic deformation) and is damage resistant to sunlight. The hinge coating 30 may be applied when the gate hinge 4 is in any position, but application when the gate hinge 4 is approximately in the mid-point between the closed and open position further reduces strain of the hinge coating 30. Various forms of paint, including rubberized paint, will work for the hinge coating 30.

FIG. 2 is a perspective view of an embodiment of the end cap 1, wherein the gate 3 is in the closed position. The end cap housing 31 is joined to a gate 3 by a gate hinge 4. The gate 3 pivots around gate hinge 4 relative to the end cap housing 31. The gate hinge 4 shown as a living hinge type, but a person skilled in the art will appreciate that other forms of hinging could be used, including a snap fit hinge or the gate 3 pivoting about a pin or axel. For living hinges a hinge coating 30 can be applied to part or all of the end cap 1, and if applied to part of the end cap 1, the hinge coating 30 is be applied in particular to the gate hinge 4 wherein the hinge coating 30 would serve to reduce sunlight caused damage to the material of the gate hinge 4. As shown in FIG. 2, the gate hinge 4 is located at the top of the hinge step 42, which serves to provide a horizontal location from which the pivoting action of the gate hinge 4 is performed. The hinge step 42 is a protrusion from the end cap housing 31. At the bottom of the gate 3 is the gate tab 18, which is an integrally formed protrusion of the gate 3 and serves to allow the user to grasp the gate 3. The gate 3 is shown in the closed position, at which the wiper insert 7 is blocked from longitudinal movement. To open the gate 3, the user pulls on the gate tab 18 according to arrow DIR. 1. When the gate 3 is in an opened position (FIG. 3) the user can pull the wiper insert out of the wiper blade. The user then can insert a new wiper insert into the wiper blade through the end cap cutout 19 (shown in FIG. 3). To close the gate 3 and therefore secure the wiper insert inside the wiper blade, the user presses on the gate 3 according to arrow DIR. 2.

Importantly, the gate hinge 4 resistant to sunlight damage is improved due to application of a hinge coating 30. Additionally, the gate tab 18 and the operation of the gate 3 is intuitive for the user because the user can see the gate hinge 4 and can understand easily the operation and purpose of the gate 3 and associated elements. Also, since no part of the end cap 1 or any of the elements therein grasp the wiper insert 7 or necessitate a special feature such as a staple or protrusion or cavity as part of the wiper insert 7, the wiper insert 7 can be removed, or installed, without these additional features and so the process is made more cost effective and easy. Another important advantage provided by the presently disclosed end cap 1 is that without the above-mentioned wiper insert 7 features, there is also a decrease in waste as a longer wiper insert 7 can be cut to meet the needs of a shorter wiper insert 7 either by the manufacturer or by the user. Lastly, since parts don't need to be removed from the wiper blade 10 or the end cap 1 during the wiper insert 7 removal and replacement beyond the wiper insert 7 itself, the user can't lose such removed parts and also doesn't need to attempt to reinstall these parts. Likewise, the wiper insert 7 only can be removed and no other parts of the wiper blade, and it doesn't require a backing strip as some inventions necessitate. This further decrease costs to the user of wiper blade 10 repair by wiper insert 7 replacements.

FIG. 3 is a perspective view of the same embodiment of end cap 1 shown in FIG. 2, wherein the gate 3 is now in the open position. With the gate 3 in the open position, the wiper insert 7 can be removed through the end cap cutout 19 and replaced. The end cap cutout 19 is an opening formed in the end cap housing 31 and the end cap cutout 19 can be of various sizes and shapes, but preferably accommodate at minimum the cross section of the wiper insert 7. For the gate 3 to move from the closed position (shown in FIG. 2) to the open position, the gate 3 has pivoted about the gate hinge 4. As shown, the wiper insert 7 is able to slide on the springs 6 in a longitudinal direction. Some wiper blade 10 prior art use the springs 6 as guides for the wiper insert 7, while other wiper blade 10 prior art use a secondary wiper insert 7 guide that is secured in other ways. Both methods of securing the wiper insert 7 are prior art and are not part of this disclosure. Embodiments of the presently disclosed end cap 1 are designed to be install on various wiper blade 10 designs, as long as the wiper insert 7 is moveable longitudinally, meaning the wiper insert 7 is not glued in place or friction fit or secured by means other than being blocked by the end cap 1. The gate 3 is latched in the closed position to the end cap housing 31 by means of the gate latch 5 interacting with the latch edge 8 of the end cap housing 31. The gate latch 5 is an integral feature of the gate 3. The latch edge 8 is an integral feature of the end cap housing 31. When the gate 3 is in the closed position, which is shown in FIG. 2, gate latch 5 is held below the latch edge 8 by the latch edge 8, which in turn latches the gate 3 in the closed position and so secures the wiper insert 7 by blocking longitudinal movement.

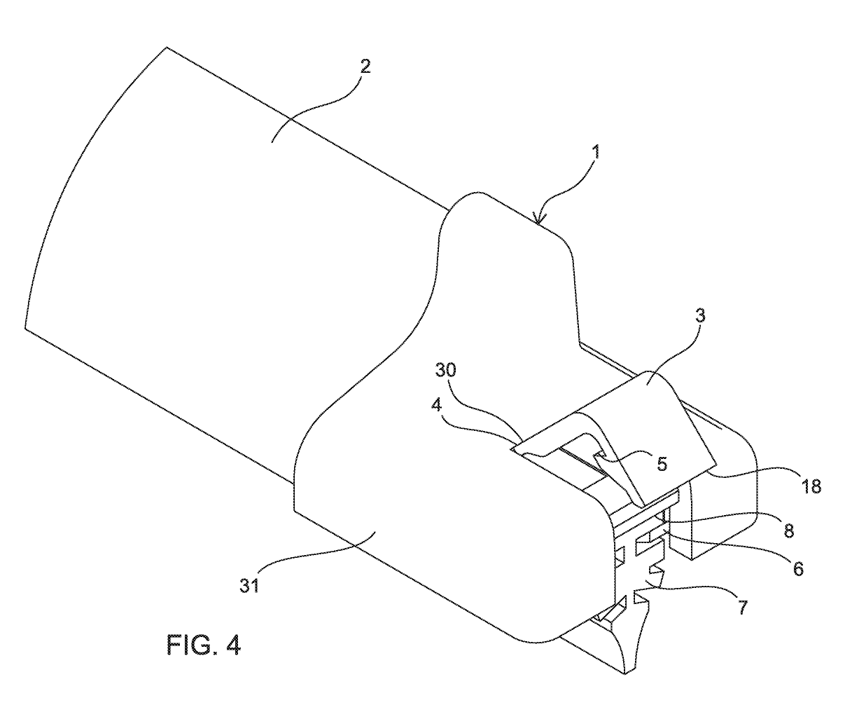

FIG. 4 show another embodiment where the gate hinge 4 position has moved nearer the end of the end cap housing 31. An additional change is that the gate latch 5 has a more acute angle which increases the strength of the latching action and so reduces the possibility of the gate 3 becoming unintentionally unlatched and moving to the open position, which then allows the wiper insert 7 to move and possible exit the wiper blade 10, which could lead to an unsafe driving condition. Using a similar acute angled latch could also be employed in the embodiment of FIGS. 2 and 3 as well as other embodiments of the end cap 1. To further protect the end cap 1 and any of its elements, especially the gate hinge 4 and especially if it's a living hinge type, a hinge coating 30 can be applied, and it can be applied to the gate hinge 4 alone or to additional elements of the end cap 1. The gate hinge 4 could alternatively be of other mechanisms, such as snap fit or a pin joint.

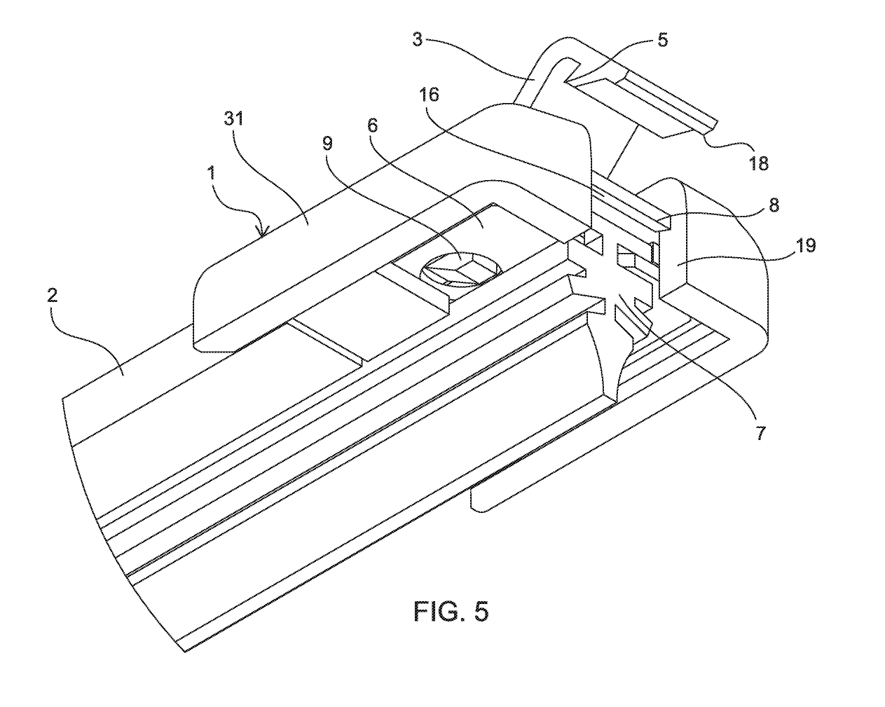

FIG. 5 illustrates the bottom of the end cap 1 featuring the same end cap 1 embodiment of FIG. 4. The end cap step 9 secures the end cap 1 to the wiper blade springs 6. The end cap step 9 is a protrusion of the end cap housing 31 and in some embodiments, the end cap 1 may comprise more than one end cap step 9. The wiper blade springs 6 are components of the wiper blade 10. This method of securing the end cap 1 to the wiper blade 10 is known in the art and can be located in other locations and be of various shapes and sizes and even operate somewhat differently but serve the same purpose, which is to secure the end cap 1 to the rest of the wiper blade 10. In the embodiment shown in FIG. 5, the latch edge 8 has an acute angle and is the one of the edges of the acute latch edge 16. The latch edge 8 engages with the gate latch 5 to create a latching mechanism to secure the gate 3 in the closed position. The acute latch edge 16 is a protrusion of the end cap housing 31.

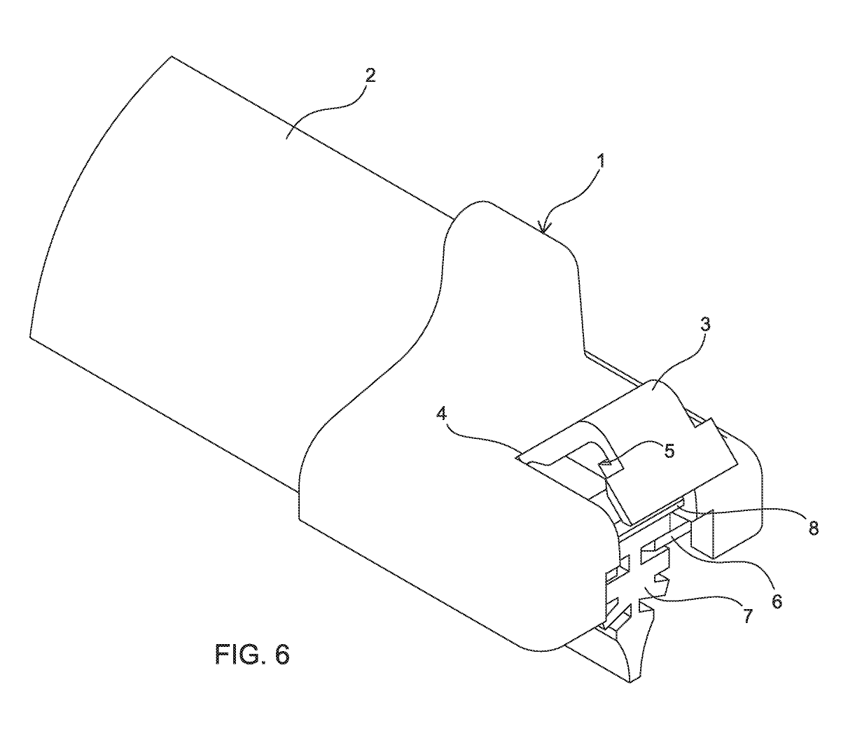

FIG. 6 is a perspective view of another embodiment of the end cap 1. The end cap 1 comprises the gate 3 and hinge 4 in the same position as the embodiment of FIG. 5, however gate 3 is significantly larger, possibly measuring the entire end cap 1 width. If the gate 3 is wider than the width between the end cap steps 9 (not shown), then the manufacturability of the end cap 1 may be improved and cost is therefore reduced.

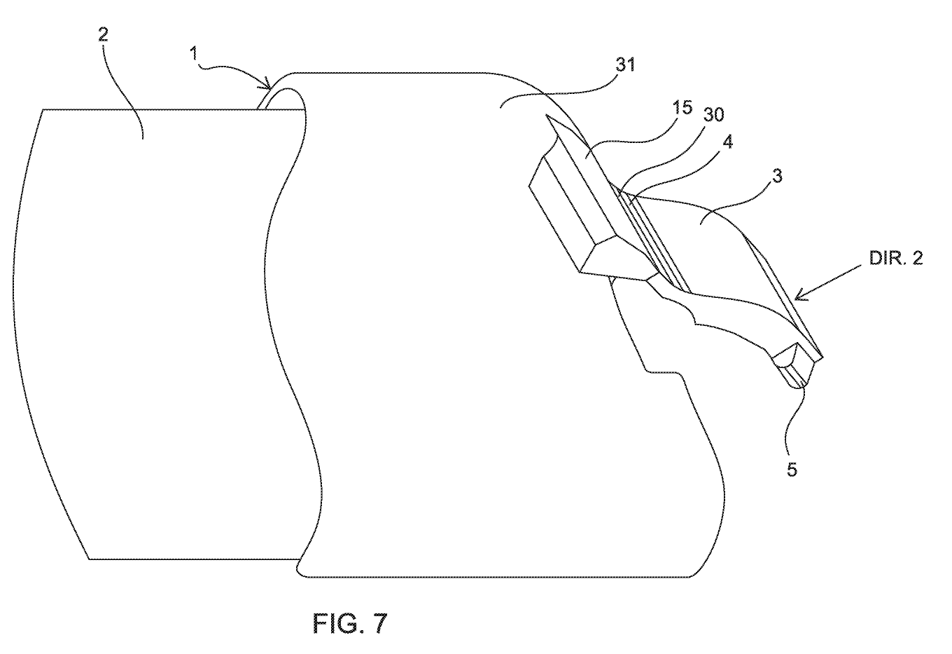

FIG. 7 is a perspective view of yet another embodiment of the end cap device 1, wherein the gate 3 and gate hinge 4 are differently positioned and the latching now occurs on the side of the gate 3. This location of the gate hinge 4 allows a certain contour of the end cap housing 31 throughout the length of the end cap housing 31, therefore avoiding a decrease in aerodynamic induced down force. This embodiment of gate hinge 4 location also minimizes angular movement of the gate hinge 4. The gate 3 is shown in the open position, hence the wiper insert 7 could be removed and a new one installed. The gate 3 is secured to the hinge cantilever 15 by gate hinge 4, which is shown as a living hinge. The hinge cantilever 15 is a protrusion from the end cap housing 31. A support may be added between the hinge cantilever 15 and the end cap housing 31 to strengthen the hinge cantilever 15. The gate latch 5 are located on the side of the gate 3. The latch edge 8 (not shown) is integral with the end cap housing 31. The gate latch 5 and latch edge 8 may be in other locations of the end cap 1, including the bottom of gate 3 similarly to the embodiment shown in FIG. 3.

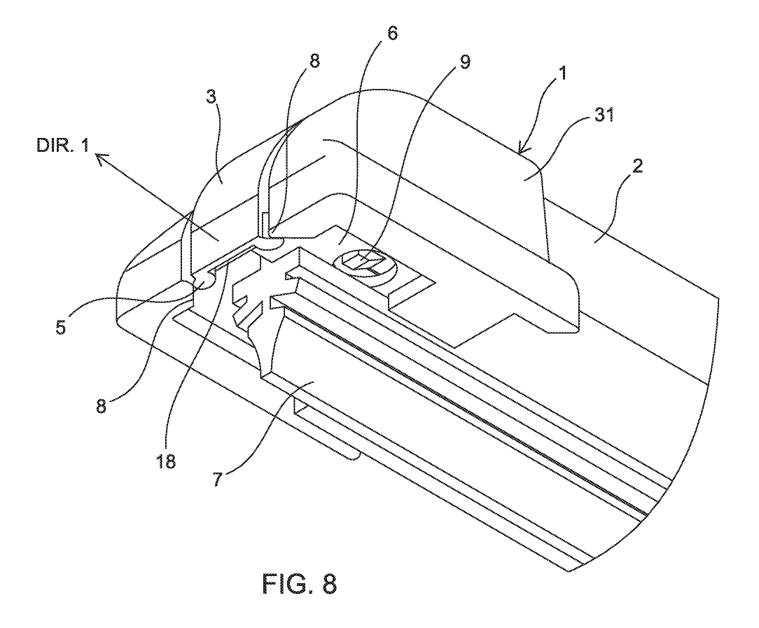

FIG. 8 is a perspective view depicting the bottom of the same end cap 1 embodiment illustrated in FIG. 7, wherein gate 3 is in the closed position. The wiper insert 7 is blocked by gate 3 when the gate 3 is in the position shown. The gate 3 is secured from movement relative to the end cap housing 31 by the interaction of gate latch 5 and the latch edge 8. The gate 3 can be made to move from the closed position to the open position by the user pulling on the gate 3 in the direction of the arrow titled DIR. 1.

FIG. 9 is an exploded view of yet another embodiment of the end cap 1 showing the bottom and front of the end of the wiper blade 10. While other embodiments are shown depicting the use of a gate hinge 4 of the living hinge type, the present embodiment shows how a gate hinge 4 can be constructed of the snap fit type. To provide additional detail, the gate 3 is shown as not installe. In normal use, the gate 3 would be assembled to the end cap housing 31 by means of the gate hinge 4. The end cap housing 31 has two hinge protrusions 34 which interact with the hinge joints 26 to serve as the gate hinge 4 and to secure the gate 3 to the end cap housing 31 in all directions except the allowed pivoting around the axis of the hinge joints 26. The hinge joints 26 are elements of the gate 3. The gate hinge 4 is located on the front and end of the end cap housing 31 but can be located in other locations of the end cap 1, including the back and end of the end cap housing 31. The hinge joints 26 bend away from each other during the assembly process until the hinge protrusion 34 is approximately concentric with the hinge joints 26, then the hinge joints 26 snap or undeforms and the hinge protrusions 34 is held within the hinge joints 26. Alternatively, the gate hinge 4 can also be built where the hinge protrusions 34 are part of the gate 3 and the hinge joints 26 are part of the end cap housing 31. Both hinge protrusions 34 can have a hinge protrusion chamfer 35 which will facilitate the installation of the hinge joints 26 over the hinge protrusion 34, at which time the hinge joints 26 will snap onto the gate hinge 4. A similar chamfer could also be on the exterior of the hinge joints 26 of the gate 3, which also facilitate the installation of the gate 3 to the end cap housing 31. In previously shown embodiments, the gate 3 and the end cap housing 31 were depicted as one piece by using a living hinge for hinge 4. In the present embodiment, the gate 3 is separate from the end cap housing 31, and then joined in an assembly process to create the end cap 1. The gate latch cavity 40 is a cavity or through hole of the gate 3.

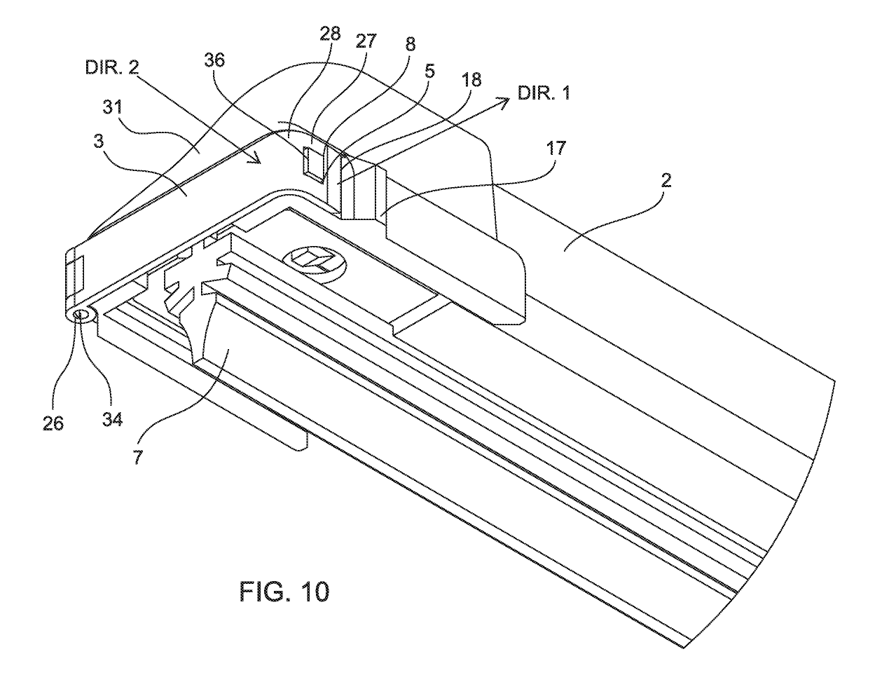

FIG. 10 is a drawing of the same embodiment of end cap device 1 as illustrated in FIG. 9, but with the gate 3 assembled to the end cap housing 31 and in a closed position and viewed from the bottom and back of the end of the end cap device 1. By pressing approximately in the direction of arrow DIR. 2, the gate latch 5 passes beyond latch edge 8 and then grasp the latch edge 8 which hinders the gate 3 from pivoting about the gate hinge 4 and secures the gate 3 to the end cap housing 31. The gate latch 5 is an edge of the gate latch cavity 40. The latch edge 8 is an edge of the latch protrusion 36, which is an element of the end cap housing 31. The latch protrusion 36 can have various protrusion distances, it can even protrude beyond the thickness of the gate 3. A greater protrusion distance for the latch protrusion 36 improves the robustness of the latching action but also requires more deflection of the gate side 27 and so more bending of the gate corner 28 and so more force by the user to unlatch the gate 3. The gate side 27 is the flat portion of the gate 3 that is approximately aligned with the back of the end cap housing 31. The gate corner 28 is the corner that joins the gate side 27 and associated elements to the rest of the gate 3. Likewise, the latch edge 8 and gate latch 5 can be angled similar to the embodiment shown in FIG. 5, which will serve to improve the latching strength, yet does not require the user to bend the gate corner 28 so far to unlatch it. Furthermore, due to the described acute angles of the gate latch 5 and latch edge 8, if the wiper insert 7 were to press against gate 3, the latching strength would increase.

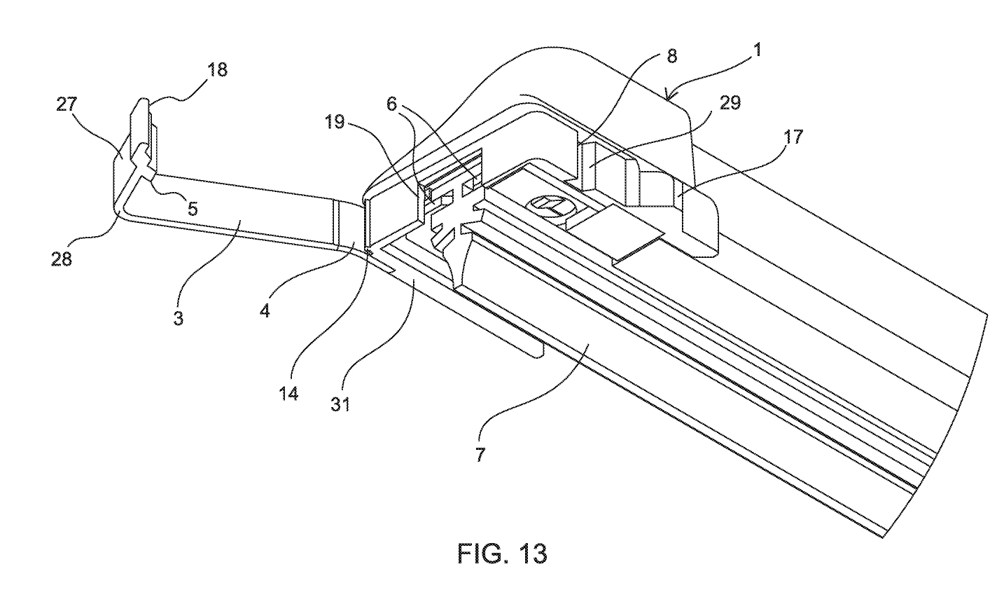

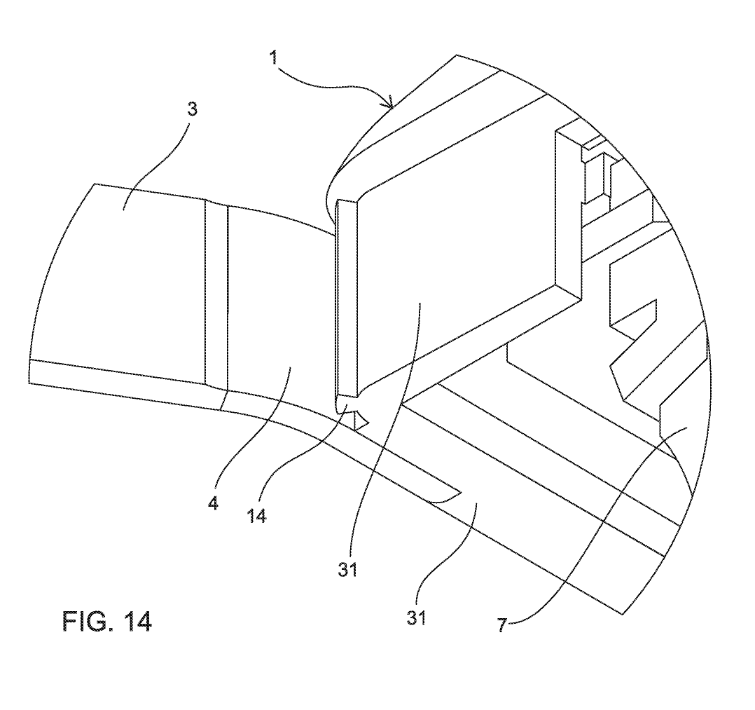

When the gate 3 is in the closed position, the wiper insert 7 is blocked from longitudinal movement and so secured. To cause the gate 3 to transition from the closed position shown in FIG. 10 to the open position which is shown in FIG. 9, the user must pull the gate tab 18 in approximately the location and direction of arrow title DIR. 1. A thinning of the gate side 27 located near the gate tab 18 may be present and will decrease the chances of objects or tools unintentionally impacting the gate tab 18, and which impact could lead to unintentional opening of the gate 3 and loss of the wiper insert 7. In an embodiment in which said thinning is present, the thickness decrease can't be so much to the affect that the gate tab 18 is too weak to function or is unable to be grasped by the user. In the embodiment shown, the gate tab 18 is protected by accidental contact with objects and tools (i.e. ice scraper, windshield washer, car wash) by the gate edge shield 17, which is a protrusion from the back of the end cap housing 31. The gate edge shield 17 is not a necessary component, and in some embodiments of the end cap of FIG. 10 it does not exist. The latching mechanism and gate tab 18 can be different from the embodiment shown in FIG. 10, including the use of a latching mechanism and gate tab 18 equivalent to that are shown in FIGS. 13 and 14 and other Figures disclosed herein.

The gate hinge 4 location and hinge type provide long service life and resistance to sunlight caused damage. The location of the gate hinge 4 receives relatively little sunlight compared to a location on the top or the back of the wiper blade 10. Likewise, the snap fit type hinge may be manufactured of resilient materials and can be made as thick as necessary to meet service life requirements. In embodiments wherein an acute latch edge 16 replaces the latch edge 8, and the gate latch 5 has an equivalent mating angle, the latching mechanism will have increasing latching strength if the wiper insert 7 were to impact the gate 3. The gate tab 18 and the operation of the gate 3 is intuitive for the user because the user can see the gate hinge 4 and can easily understand the operation and purpose of the gate 3 and associated elements. Since no part of the end cap 1 or any of the elements therein grasp the wiper insert 7 or necessitate a special feature such as a staple or protrusion or cavity as part of the wiper insert 7, the wiper insert 7 can be removed and replaced without these additional features and so can be made more cost effectively. Without such wiper insert 7 features, there will also be a decrease waste as a longer wiper insert 7 without such features can always be cut to meet the needs of a shorter wiper insert 7 by the manufacturer or the user. Lastly, since parts don't need to be removed from the wiper blade 10 or the end cap 1 during the wiper insert 7 removal and replacement, beyond the wiper insert 7, the user can't lose such removed parts and also doesn't need to attempt to reinstall these parts. Likewise, the wiper insert 7 can be removed alone, it doesn't require a backing strip as some inventions require. This further decreases the cost to the user of wiper blade 10 repair by wiper insert 7 replacements.

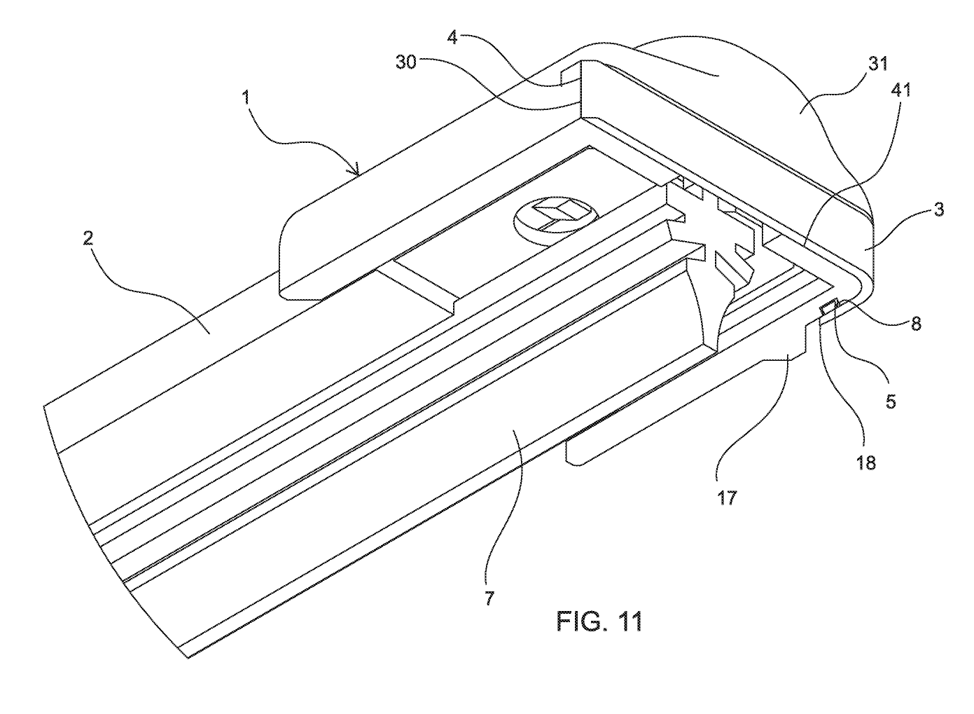

FIG. 11 shows a perspective view of yet another embodiment of the end cap 1 from the bottom front of the end cap 1. The present embodiment is similar to the one shown in FIG. 9 and FIG. 10, but with an alternative hinge type and changes to the latching method. The gate 3 is joined to the end cap housing 31 by gate hinge 4, which is of the living hinge type. The gate 3 is shown in the closed position. To keep the gate 3 in the closed position, the gate latch 5 engages with the latch edge 8. Compared to the latch protrusion 36 coming from the end cap housing 31 as in the embodiment of FIG. 9 and FIG. 10, there is a cavity in the end cap housing 31 that the gate latch 5 drops into and then the gate latch 5 grasp the latch edge 8, which then secures the gate 3 to the end cap housing 31. A gate edge shield 17 may be present and serves to shield the gate latch 5 from being unintentionally opened by objects moving on the wind shield (e.g. ice scrapper, hand operated wind shield washer, car wash items). There is enough distance between the gate edge shield 17 and the gate tab 18 that the user can use a finger or fingernail to pull on the gate tab 18, which then moves the gate 3 to the open position. To close and latch the gate 3 to the end cap housing 31, the user presses on the gate 3 in the middle of its largest length, which as shown is immediately in front of the wiper insert 7.

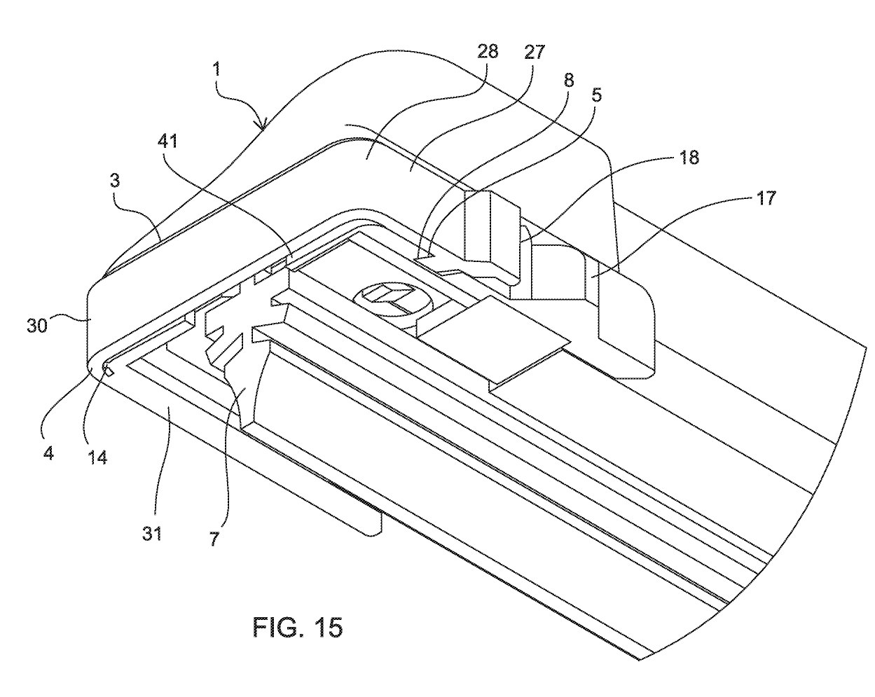

There must be space between the gate 3 and end cap housing 31, so that the gate 3 can rotate far enough to cause the gate latch 5 to pass the latch edge 8 and engage. This space is termed gate to housing space 41. The arrow 41 only points to the location of where the gate to housing space 41 needs to be present, but it is not present in this drawing. It is drawn in a clearer form in FIG. 15.

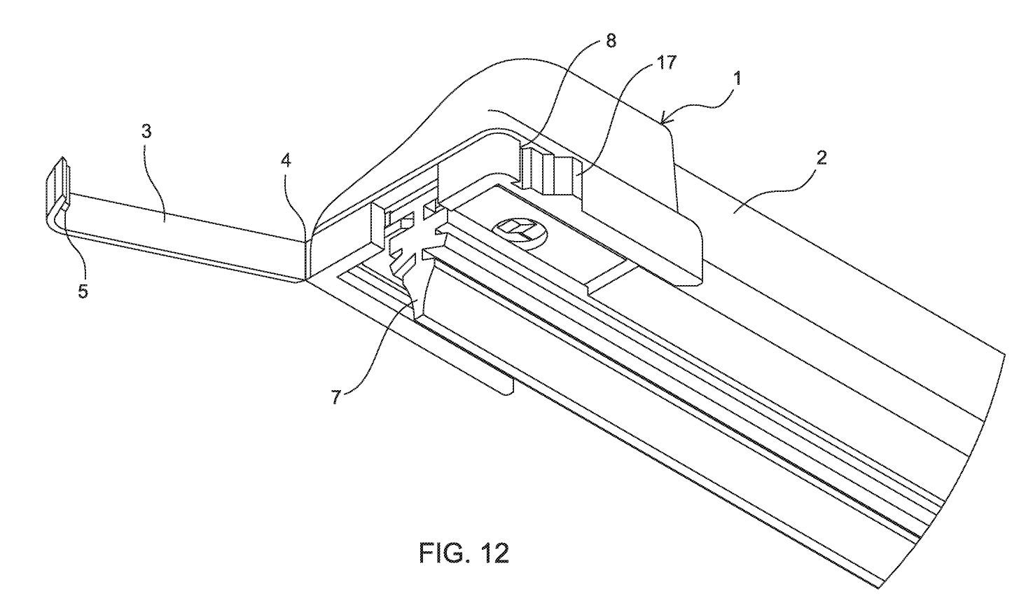

FIG. 12 is a perspective view of the same embodiment shown in FIG. 11, but with the gate 3 in the open position. In this position, the wiper insert 7 can be removed and replaced. Shown is the acute angles of the gate latch 5 and the latch edge 8. This serves to create a robust latch action that latches harder in the event a force is applied to the gate 3, i.e. the wiper insert 7 potentially pressing on the gate 3. The latch angle must not be so acute that it will be impossible for the user to open or close the gate 3.

The gate hinge 4 location will lead to long service life and resistance to sunlight caused damage. If a hinge coating 30 in applied over the gate hinge 4, the service life may be further increased. The location of the gate hinge 4 will receive relatively little sunlight compared to a location on the top or the back of the wiper blade 10. The gate tab 18 and the operation of the gate 3 is intuitive for the user because the user can see the gate hinge 4 and can understand the operation and purpose of the gate 3 and associated elements. Since no part of the end cap 1 or any of the elements therein grasp the wiper insert 7 or necessitate a special feature such as a staple or protrusion or cavity as part of the wiper insert 7, the wiper insert 7 can be without these additional features and so can be made more cost effectively. Without such wiper insert 7 features, there will also be a decrease waste as a longer wiper insert 7 without such features can always be cut to meet the needs of a shorter wiper insert 7 by the manufacturer or the user. Lastly, since parts don't need to be removed from the wiper blade 10 or the end cap 1 during the wiper insert 7 removal and replacement, beyond the wiper insert 7, the user can't lose such removed parts and also doesn't need to attempt to reinstall these parts. Likewise, the wiper insert 7 can be removed alone, it doesn't require a backing strip as some inventions require. This further decreases the cost to the user of wiper blade 10 repair by wiper insert 7 replacements.

FIG. 13 is a perspective view of yet another embodiment from the bottom and back and end of the wiper blade 10 showing the end cap 1 comprising the end cap housing 31 and the gate 3, which are connected by means of a gate hinge 4 which is of the living hinge type. The gate hinge 4 that joins the gate 3 to the end cap housing 31 is shown located at the end cap housing 31 front corner. Other gate hinge 4 locations may be used, including the back and end corner of the end cap housing 31.

In the embodiment of FIG. 13, the gate hinge 4 is considerably thicker than a standard living hinge. This thicker hinge material may increase the resistance of the hinge to sunlight damage because considerably more material must be damaged prior to failure of the gate hinge 4. Living hinges are generally of very thin material so that material strain is decreased. Thicker material can be used in this embodiment because of an increase in the radius of the gate hinge 4 when the gate 3 is in the closed position (shown in a FIG. 15).

For the purpose of increasing the gate hinge 4 radius, a hinge bulwark 14 may be provided, which is a protrusion of the end cap housing 31 which hinge bulwark 14 serves to hold the material of the gate hinge 4 in an approximately circular path at maximum radius for all points along the gate hinge 4.

The gate tab 18 protrudes from the gate side 27 of the gate 3 which serves to make grasping for opening the gate 3 easier for the user. To protect the gate tab 18 from damage or accidental contact with foreign objects like ice scrapers or wind shield squeegees, a gate edge shield 17 may be added and formed as a protrusion from the end cap housing 31 and located on the back of the end cap housing 31 and near to the gate tab 18.

In FIG. 13 the gate 3 is shown in the open position, wherein the wiper insert 7 can be removed and replaced by sliding longitudinally. Shown is the gate latch 5 and latch edge 8, which latch together to secure the gate 3 when in the gate 3 is in the closed position. As shown, the latch edge 8 is the edge of the latch cavity 29 which is the edge most near the end of the end cap housing 31. The angles of the gate latch 5 and the latch edge 8 may be acute as shown in FIG. 13, which will serve to improve the strength of the latching action. The gate latch 5 is a protrusion from the gate 3 and is shown located near the gate tab 18 of the gate side 27 of gate 3. This location for the gate latch 5 will reduce the force needed by the user to pull on the gate tab 18 to open the gate 3, which operation requires the gate latch 5 pass the latch edge 8. This unlatching action requires the gate side 27 be pulled away from the end cap housing 31 and so will cause the gate 3 to bend at the gate corner 28. The gate corner 28 and gate side 27 are elements of the gate 3. The gate latch 5 could be located at various other locations on the gate side 27 of the gate 3.

When the gate 3 is in the open position as shown in FIG. 13, the natural angle the gate 3 returns to can be greater than 90° from the closed position shown in FIG. 15. As shown, gate 3 is beyond 90° and this larger movement angle serves at least these two purposes; additional room to remove the wiper insert 7 passed gate side 27 and the gate tab 18 and secondly allowing a longer gate side 27. The longer gate side 27 serves to reduce the strain on the gate corner 28 of gate 3, the strain being because the gate corner 28 will deform during the latching and unlatching of gate 3. The gate corner 28 deformation angle and associate strain is proportionally related to the distance between the gate side 27 and the gate latch 5 (the height of the male latching feature) and inversely proportional to distance between the gate latch 5 and the gate corner 28. The latch cavity 29 and latch edge 8 are shown as features of the end cap housing 31 while the gate latch 5 is shown as part of the gate 3. In some embodiments, the gate latch 5 is a protrusion from the end cap housing 31 and the latch edge 8 and latch cavity 29 are elements of the gate 3.

The angle between the gate 3 and the gate side 27 can be less than 90°, which will serve to press the gate latch 5 into the latch cavity 29 and latch edge 8 which will improve latching reliability and resilience. The angle between the gate 3 and gate side 27 cannot be so acute that the gate tab 18 impacts the end cap housing 31 during the closing movement of gate 3 and the impact or binding cannot be accomplished without component damage or user injury.

FIG. 14 is a detailed perspective view of the same embodiment of end cap 1 shown in FIG. 13 with specific attention to how the gate hinge 4 joins the gate 3 to the end cap housing 31 by a rather large radius. The hinge bulwark 14 is shown as protruding from the end cap housing 31 and having a rounded surface. The hinge bulwark 14 serves to direct the gate hinge 4 to a large radius when the gate 3 is in the closed position. The increased radius reduces material strain of gate hinge 4 during the gate 3 rotational movement and when in the closed position. Material strain for bends is proportional to thickness and inversely proportional to radius. As shown, the gate hinge 4 radius is approximately three times larger than a standard living hinge and approximately three times thicker. With thicker hinge 4 material, the longevity of the gate hinge 4 will be increased because sunlight damage will take longer to cause the failure of the gate hinge 4, by which time the wiper blade 10 will have normally have been replaced. The hinge bulwark 14 may be a radius of the bulk of the end cap housing 31 encompassing the entire length of the inner hinge 4 radius, however, the hinge bulwark 14 as shown reduces sticking, possibly caused by ice, by reducing the contact area between the inner surface of hinge 4 and the outer surface of the hinge bulwark 14. The outer surface of the hinge bulwark 14 can be rounded as shown, but it is not necessary so. Furthermore, there can be multiple hinge bulwarks 14, that approximate the inner radius of the gate hinge 4 while the gate 3 is in the closed position. Any such hinge bulwark 14 could be of a slot shape that protrudes from the end cap housing 31 and where the shorter end is in contact with the gate hinge 4. A hinge bulwark 14 is not necessary for proper operation of the gate 3 and hinge 4, as the gate hinge 4 will natural follow the desired curvature. However, the hinge bulwark 14 provide backing support for possible damage to the gate hinge 4 caused by impacts.

FIG. 15 is an illustration of the same embodiment as shown in FIGS. 13 and 14, with perspective from the bottom and back and end of the wiper blade 10 and showing the end cap 1 comprising end cap housing 31 and gate 3 in the closed position, as well as other elements. With the gate 3 pivoted by means of the gate hinge 4 and in the closed position, the gate hinge 4 can be seen to have deformed around the hinge bulwark 14 but kept a large radius that will reduce the strain of the material of the gate hinge 4. It is not necessary, but a hinge coating 30 can be applied to part or all of hinge 4 or even the entire end cap 1, which further improves the longevity of the gate hinge 4. The hinge coating 30 can be applied when the gate 3 is any position along its path, but may be applied when the gate 3 is approximately half way between the open position and closed, which will serve to reduce the strain on the hinge coating 30 when the gate 3 is in either position. If a hinge coating 30 is applied, it should cover any part of the gate hinge 4 that is exposed to direct sunlight during normal use when the gate 3 is in the closed position, this would apply to at least the exterior of the gate hinge 4 and the top of the gate hinge 4. There must be space between the inside surface of gate 3 and end of the end cap housing 31, so that the gate 3 can move far enough to cause the gate latch 5 to pass the latch edge 8 and engage. This space is termed gate to housing space 41. FIG. 15 shows the gate 3 in the closed position and the wiper insert 7 is blocked from longitudinal movement by gate 3, and so the wiper insert 7 is secured.

The gate hinge 4 location and the thickened gate hinge 4 material will lead to long service life and resistance to sunlight caused damage. The location of the gate hinge 4 will receive relatively little sunlight compared to a location on the top or the back of the wiper blade 10. The gate tab 18 and the operation of the gate 3 is intuitive for the user because the user can see the gate hinge 4 and can understand the operation and purpose of the gate 3 and associated elements. Since no part of the end cap 1 or any of the elements therein grasp the wiper insert 7 or necessitate a special feature such as a staple or protrusion or cavity as part of the wiper insert 7, the wiper insert 7 can be without these additional features and so can be made more cost effectively. Without such wiper insert 7 features, there will also be a decrease waste as a longer wiper insert 7 without such features can always be cut to meet the needs of a shorter wiper insert 7 by the manufacturer or the user. Lastly, since parts don't need to be removed from the wiper blade 10 or the end cap 1 during the wiper insert 7 removal and replacement, beyond the wiper insert 7, the user can't lose such removed parts and also doesn't need to attempt to reinstall these parts. Likewise, the wiper insert 7 can be removed alone, it doesn't require a backing strip as some inventions require. This further decreases the cost to the user of wiper blade 10 repair by wiper insert 7 replacements.

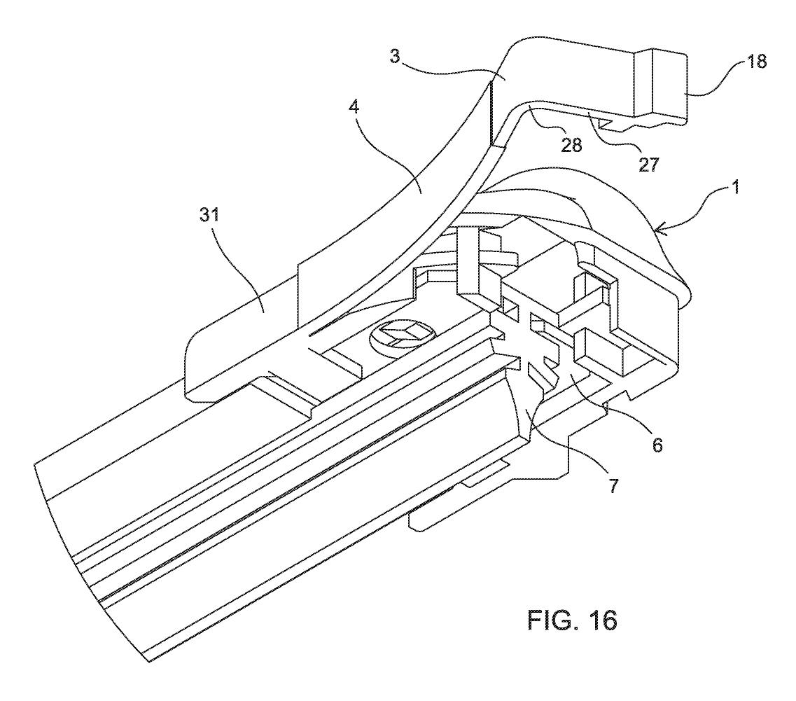

The same embodiment as depicted in FIGS. 13, 14, and 15 is shown in FIG. 16 featuring an even larger rotation radius for hinge 4. This further serves to reduce material strain of the gate hinge 4, which joins the gate 3 to the end cap housing 31 and serves to allow the gate 3 to pivot between the open position shown in FIG. 16 and the closed position shown in FIG. 15. To accommodate the larger radius, the end cap housing 31 is lengthened to create more distance between the spring end 33 and the inside of hinge 4 when the gate 3 is in the close position. The spring end 33 is the end of the spring 6. As shown, the gate 3 is in the open position and so the wiper insert 7 can slide longitudinally and so can be removed and new wiper insert 7 installed.

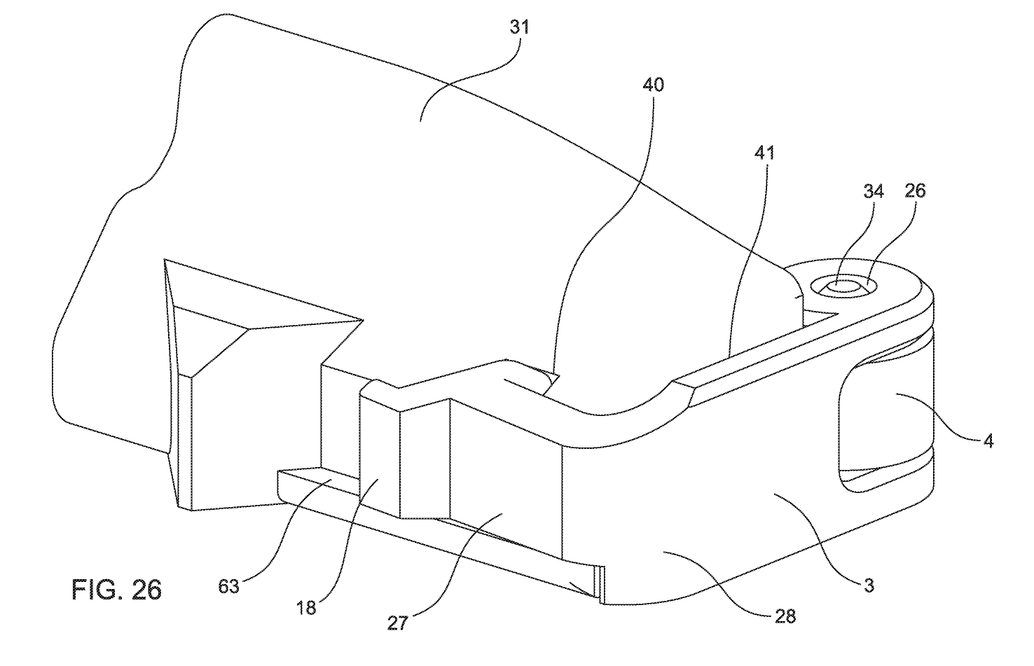

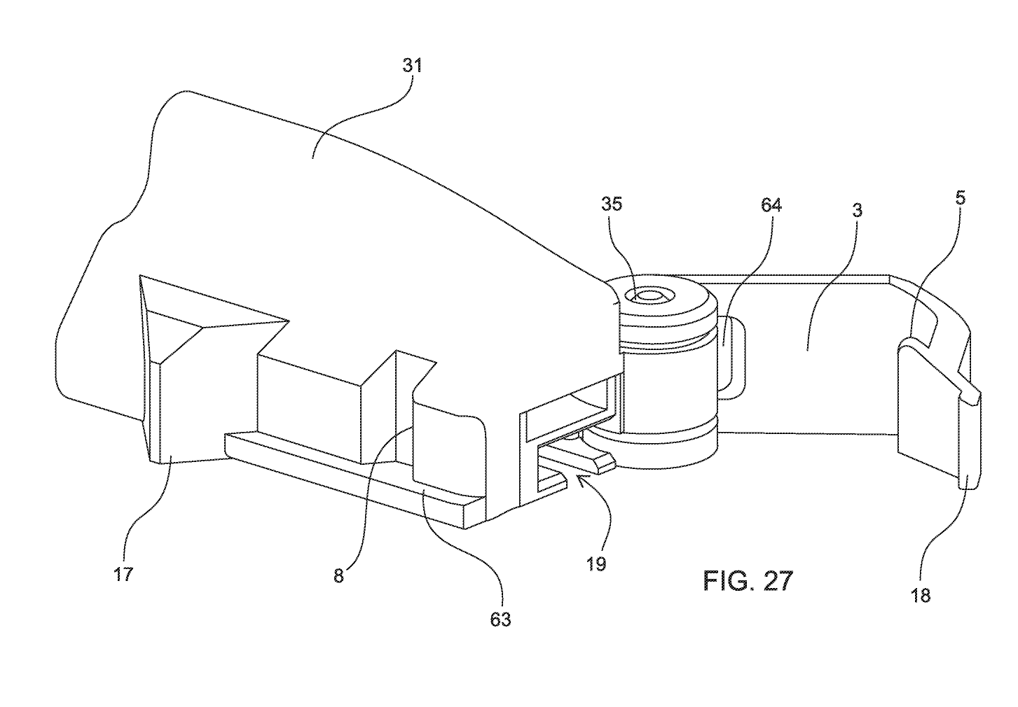

Referring now to FIGS. 26 and 27, FIG. 26 depicts an embodiment of the end cap device 1, wherein the device is not attached to a wiper blade and the gate 3 is closed. The embodiment shown in FIG. 26 features a hinge 4 of the snap fit type and acute angles of the gate latch 5 and the latch edge 8. The embodiment of FIG. 26 also comprises a gate bottom guide 63 and gate edge shield 17. The gate edge bottom guide 63 is integral with the end cap housing 31 and serves to hold the gate 3 in position. FIG. 27 depicts the same embodiment of end cap 1 shown in FIG. 26 wherein the gate 3 is in an opened position and the end cap cutout 19 is shown as well as the gate hinge opening 64 which is space between the hinge joints 26 and allows deformation during the gate 3 to end cap housing 31 assembly.

Generally, to operate the end cap devise 1 according to the embodiments illustrated in FIGS. 1-16 and described herein, one uses the wiper blade 10 in a normal manner, against the vehicle windshield. When the wiper blade 10 has degraded in performance and the wiper insert 7 is found to be the cause, the wiper insert 7 can be replaced as follows. The user lifts the wiper blade 10 off of vehicle or removes it from the vehicle, then pulls on the gate tab 18 in a direction away from the end cap housing 31 until the gate 3 moves to the open position. The user pulls the wiper insert 7 out of wiper blade 10. Then the user inserts a new wiper insert 7 into the wiper blade 10 through the end cap cutout 19. Then the gate 3 is pressed until it latches in the closed position. If needed, the user centers the wiper insert 7 in the wiper blade 10. Lastly the wiper blade 10 is returned to the windshield of the vehicle and returned to normal use.

In some embodiments, the present disclosure provides a cap end device 1 that secures wiper insert with elastic gate.

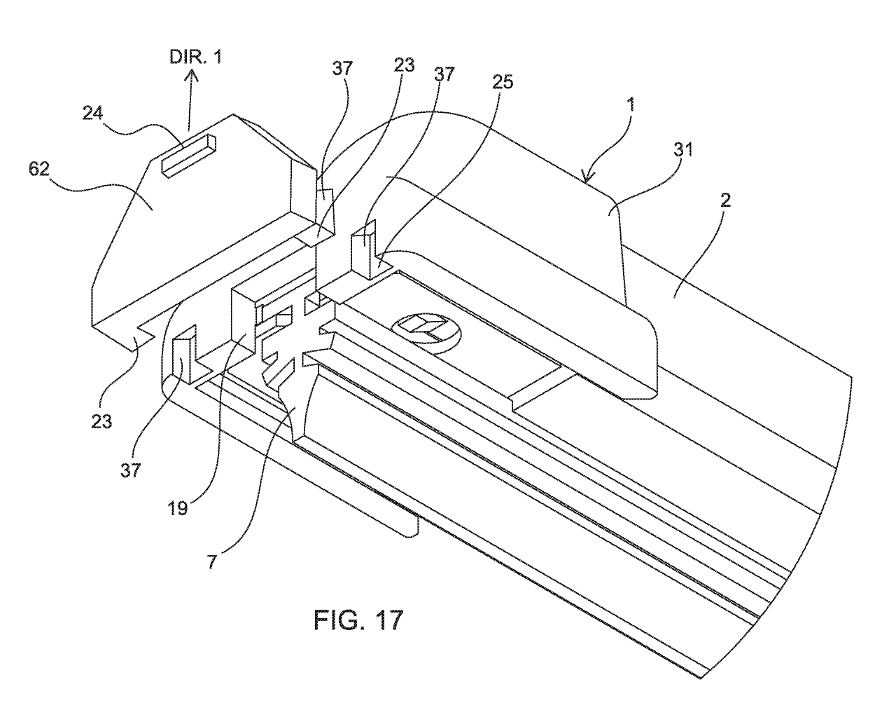

FIG. 17 is a detailed exploded perspective drawing of another embodiment of the end cap device 1, viewed from the bottom and end of a wiper blade 10. In the previously shown and described embodiments the end cap device 1 had a gate 3 made of a material that was deformable such as a thermoplastic. This presently shown embodiment has an elastic gate 62 made of a deformable material that is more elastic, such as rubber or silicone or another material with similar elastic properties. The material of the elastic gate 62 is preferably resistant to damage caused by sunlight.

In FIG. 17, the elastic gate 62 is shown not installed to provide additional detail. The elastic gate 62 can be made as a separate part from the end cap housing 31 or integral formed to the end cap housing 31. If the elastic gate 62 is a separate part, it can be adhered or cohered to the end cap housing 31 on the sides and/or top of the gate edge lug 23 using an adhesive 37. In the embodiment that the elastic gate 62 is a separate part, said gate 62 can adhered or secured to the end cap housing 31 using any suitable mean such as, without limitation, glue or any type of adhesive material, magnetic force, fasteners or latches. The gate edge lug 23 can be a protrusion from the elastic gate 62 and serves to join the elastic gate 62 to the end cap housing 31. Alternatively, the elastic gate 62 could be made as part of the end cap housing 31, one method being a multi-shot injection molding process. For such a process, a masking material may be placed such that the elastic gate 62 is secured at locations near gate edge lug 23 to the end cap housing 31 and not secured at or above the end cap cutout 19. The end cap cutout 19 being an opening in the end of the end cap housing 31. The end cap cutout 19 may be much wider than the wiper insert 7, but must at a minimum sized to allow the wiper insert 7 to be withdrawn through the end cap cutout 19. If the gate edge lug 23 is a protrusion, then an opposing cavity here named the gate lug cavity 25 is created. The top edge of the gate edge lug 23 and gate lug cavity 25 can be angled as shown, which will cause the gate edge lug 23 to be more secure in the gate lug cavity 25. The sides of the gate lug cavity 25 and gate edge lug 23 can also be angled similarly, especially the sides closest to the end cap cutout 19, meaning the exterior edges of the gate lug cavity 25 on the end of the end cap housing 31 are acute angles. The gate edge lug 23 and associated gate lug cavity 25 can be located as shown or can be located at the round edges of the end cap housing 31 or around the edge on the front and back of the end cap housing 31. The edge at the top of the gate lug cavity 25 may be rounded or chamfered to eliminate the possibility of the gate lug cavity 25 cutting through the gate edge lug 23. The edges at the sides of the gate lug cavity 25 may also be rounded or chamfered.

The elastic gate 62 has two positions and is shown in the closed position in FIG. 16. The elastic gate 62 is elastically deformed to transition from the closed position and the open position (which is shown in FIG. 17). While the elastic gate 62 is in the closed position, it blocks the longitudinal movement of the wiper insert 7 and so secures the wiper insert 7 to the wiper blade 10. The end cap housing 31 secures to the wiper blade 10 through normal means described in prior art and is not be described in this section of this disclosure.

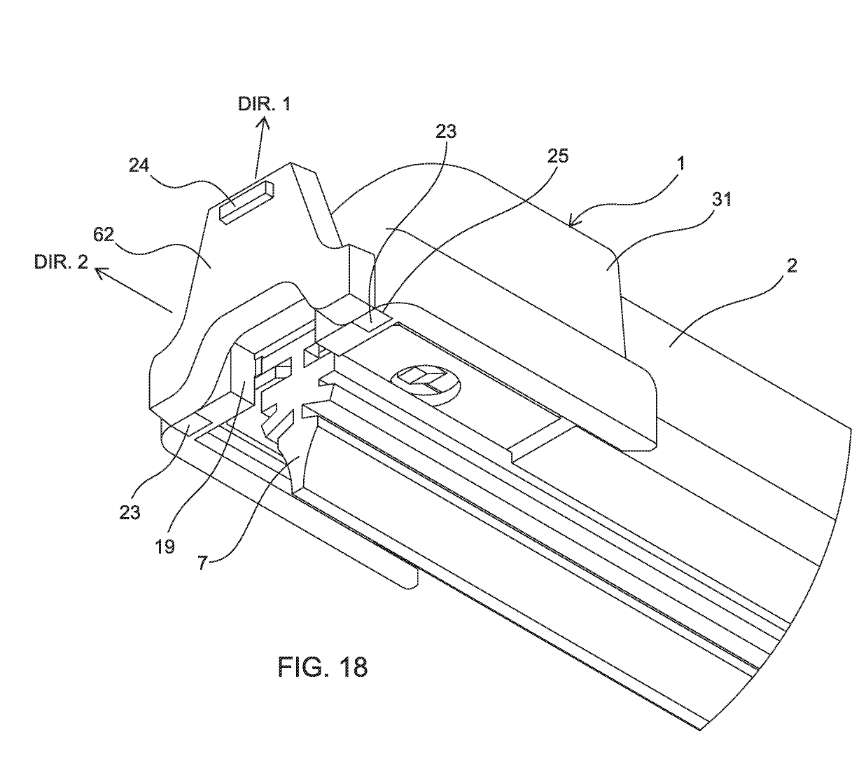

FIG. 18 shows a bottom view of the same embodiment as FIG. 17, but with the elastic gate 62 elastically deformed until it is in the open position. The elastic gate 62 is deformed when elastic gate 62 has been pulled by the gate pull tab 24 in the approximate direction of arrow DIR. 1. The gate pull tab 24 is one or two protrusions located on the elastic gate 62 approximately as shown in FIG. 17. Once the elastic gate 62 has been deformed sufficiently, the end cap cutout 19 is exposed and the wiper insert 7 can be withdrawn in the direction of arrow DIR. 2 and a new wiper insert 7 can be installed in the direction opposite of arrow DIR. 2.

The elastic gate 62 needs to be of appropriate elasticity and thickness to block the wiper insert 7 during normal use and also not tear when being pulled using the gate pull tab 24 as intended. However, the elastic gate 62 cannot be so thick or inelastic that it can't be pulled and deformed by the user without undue force.

Generally, to operate the end cap devise 1 according to the embodiments illustrated in FIGS. 17 and 18 and described herein, one uses the wiper blade 10 in a normal manner, against the vehicle windshield. When the wiper blade 10 has degraded performance and the wiper insert 7 is found to be the cause, the wiper insert 7 can be replaced as follows. User lifts wiper blade 10 off of vehicle windshield or removes wiper blade 10 from vehicle and then pulls on gate pull tab 24 to elastically deform the elastic gate 62 sufficiently to allow the wiper insert 7 to be partially or fully removed. The wiper insert 7 is fully removed from the wiper blade 10 through the end cap cutout 19, which is exposed by the deformed elastic gate 62. The user can continue to pull on the gate pull tab 24 when removing the wiper insert 7, but it isn't necessary to continue to do so. With the old wiper insert 7 fully removed, the user readies the new wiper insert 7 for installation and then pulls the gate pull tab 24 to expose the end cap cutout 19 and then slides a new wiper insert 7 into wiper blade 10. Once the wiper insert 7 is at least partially installed, the user can stop pulling on the gate pull tab 24. Once the wiper insert 7 is fully installed in the wiper blade 10 and has stopped pulling on the gate pull tab 24, the elastic gate 62 will naturally return to the original un-deformed and closed position. The user then must verify the wiper insert 7 is fully installed within the wiper blade 10 and the elastic gate 62 is blocking the wiper insert 7 and the elastic gate 62 is in the closed position. If needed, the user centers the wiper insert 7 in the wiper blade 10. Lastly the wiper blade 10 is then returned to the windshield of the vehicle and returned to normal use.

In some embodiments, the present disclosure provides a device that presses against wiper insert to secure said wiper insert.

Previous device embodiments described in this disclosure had two states, one where the wiper insert 7 was blocked from longitudinal movement and a second state where the wiper insert 7 was free to move longitudinally. The device described below, is comprised of the center block 12 and open end cap 38, and also has two states. In one state or position, the wiper insert 7 will be secured by friction caused by an element named the center link stud 21 disclosed herein that presses against the wiper insert 7. In a second state, achieved by rotating the wiper blade, the center link stud 21 no longer presses on the wiper insert 7 and therefore its removal and replacement are enabled. The wiper blade 10 is shifts between the two states, as will be described below, by rotating the wiper blade 10. The presently disclosed center block 12 thus provides the advantage of replacing the wiper insert 7 when the wiper blade 10 is approximately upside down which is most convenient. Therefore, turning over the wiper blade 10 performs two valuable actions, first to more easily access the wiper insert 7 and second make the wiper insert 7 removable.

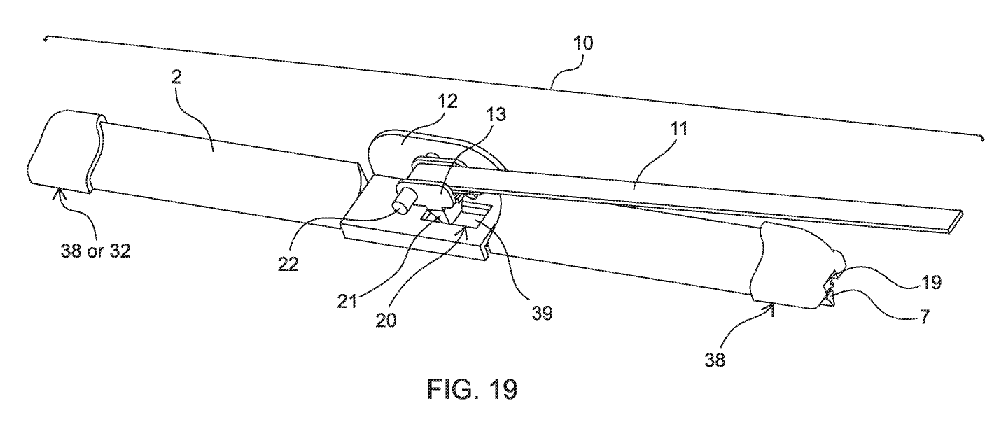

FIG. 19 is a sectional view of a center block 12 from the top front of a wiper blade 10. The front half of the center block 12 is not shown to allow the viewer to see more details. Center blocks are standard component of wiper blades and serves as the central foundation of the wiper blade. Center blocks commonly adhered to the spring(s). Other elements of the wiper blade are then secured to either the center block or springs. Importantly, the presently disclosed center block 12 also performs the functions of securing and releasing the wiper insert 7, these functions are facilitated by the center block cutout 20.

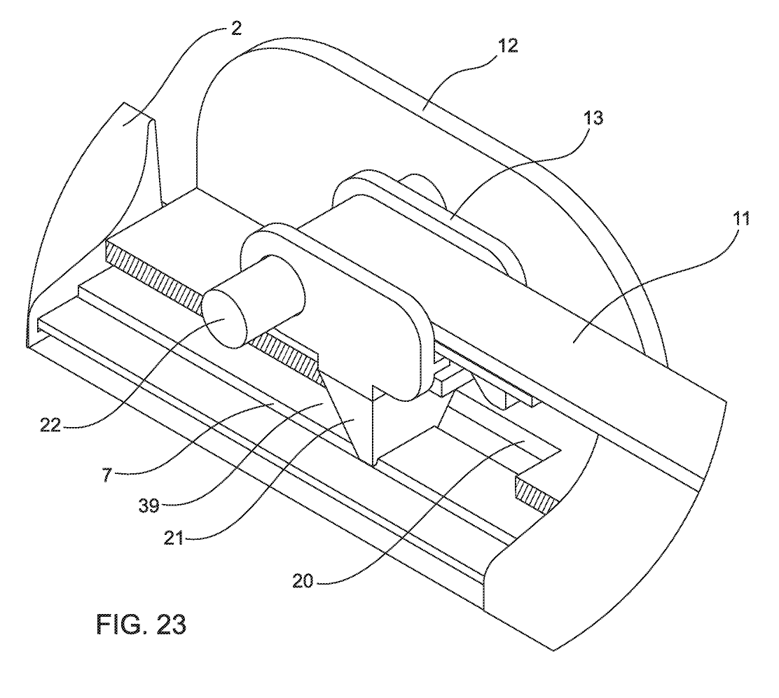

The wiper arm 11 is a component of the vehicle and it facilitates the wiper blade 10 movement that cleans the windshield. The wiper arm 11 connects to the wiper blade 10 by the wiper arm link 13 which is by itself a separate component. The center block 12 disclosed herein provides a link shaft 22 which allows the wiper blade 10 to pivot (rotate) relative to the wiper arm 11 and the wiper arm link 13. The link shaft 22 is commonly integrally formed with the center block 12 and is a standard in the art. Part of the wiper arm link 13 is the center link stud 21 which protrudes towards the base of the wiper blade 10. The center link stud 21 can be a protrusion of the wiper arm link 13 or can be a second component that is secured by various means to the wiper arm link 13, including adhesives or cohesive or mechanical means such as a fastener or a snap fit joint. The center link stud 21 may have a decreasing cross section, i.e. its profile tapers as illustrated clearly at least in FIG. 23. At the base of the center block 12 there is a center block cutout 20 which can be of various sizes and shapes but must allow the passage of the center link stud 21. Immediately below the center block cutout 20 is the back of the wiper insert 7 termed the top strip 39. The location of the top strip 39 immediately below the center of the center block 12 is a natural occurrence of how many frameless wiper blades are made.

When the wiper blade 10 is laid against the vehicle windshield, the center link stud 21 shifts towards the top strip 39 and presses the top strip 39, which pressing interaction secures the wiper insert 7 to the wiper blade 10. When the wiper blade 10 is rotated about the link shaft 22, the center link stud 21 rotates away from the top strip 39 and does not press on the top strip 39, and so the wiper insert 7 is not secured to the wiper blade 10.

When the wiper insert 7 is not secured, it can be removed and replaced by sliding longitudinally through the end cap cutout 19 of the open end cap 38. The open end cap is another embodiment of the end cap 1, in which no gate 3 exist, but rather there is an opening in the end cap 1 enabling removal and replacement of a wiper insert 7. Thus, the open end cap 38 has an end cap cutout 19 which is sized to allow the wiper insert 7 to pass through the open end cap 38.

The center link stud 21 is located below the link shaft 22 and on the side of the wiper arm 11. Therefore, the wiper arm 11 with the wiper arm link 13 and center link stud 21 can all move as one around the link shaft 22 and form a class two lever, which has a load that is the center link stud 21 pressing against the top strip 39. In this way, the center link stud 21 will apply a significant force against the top strip 39, which leads to friction and thus secures the wiper insert 7 within the wiper blade 10. The wiper blade 10 can have two open end caps 38 or only one with the other end of the wiper blade 10 having a standard end cap 32. If there is only one open end cap 38 on the wiper blade 10, it should be the located so that after the wiper arm 11 is off the windshield and the wiper blade 10 is inverted, it is the nearest part of the wiper blade 10 to the user.

The end cap 38, the center block 12, the wiper arm link 13 and the center link stud 21 can be made from various materials or combinations of them, with thermoplastic, stainless steel, spring steel, and aluminum being some of them.

In another embodiment, the center link stud 21 not part of the wiper arm link 13 but a separate component fixed to the wiper blade 10 or an element of another component of the wiper blade 10, including the open end cap 38, the standard end cap 32, the end cap 1—if installed, the wind deflector 2, or the center block 12. The center link stud 21 can be latched in at least the state where it presses against the top strip 39. Whether it is an element of another component or a separate component, the center link stud 21 must be movable relative to the top strip 39 and this movement could be translational (slideable) or pivoting or rotational. The user unlatches the center link stud 21 so it no longer presses on the top strip 39 which then causes the wiper insert 7 to be free to be removed and replaced.

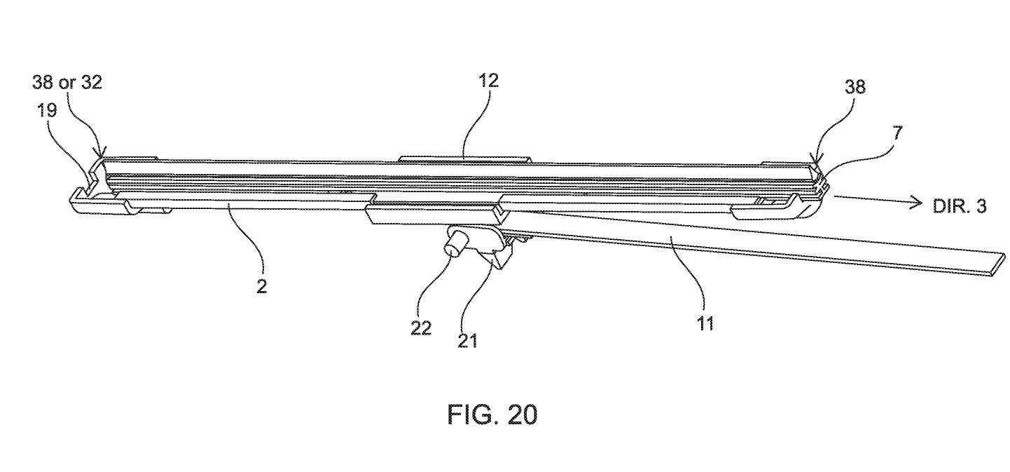

FIG. 20 shows the same embodiment of FIG. 19, but with the wiper blade 10 turned over. With the wiper blade 10 so inverted, the center link stud 21 is no longer in contact with the top strip 39 of the wiper insert 7, and so the wiper insert 7 is not secured and can be removed according to arrow DIR. 3. Shown is the end cap cutout 19 of the open end cap 38, which allows the movement of the wiper insert 7 beyond the open end cap 38. To allow the viewer to better understand the embodiment, the front half of the center block 12 is not shown in FIG. 20.

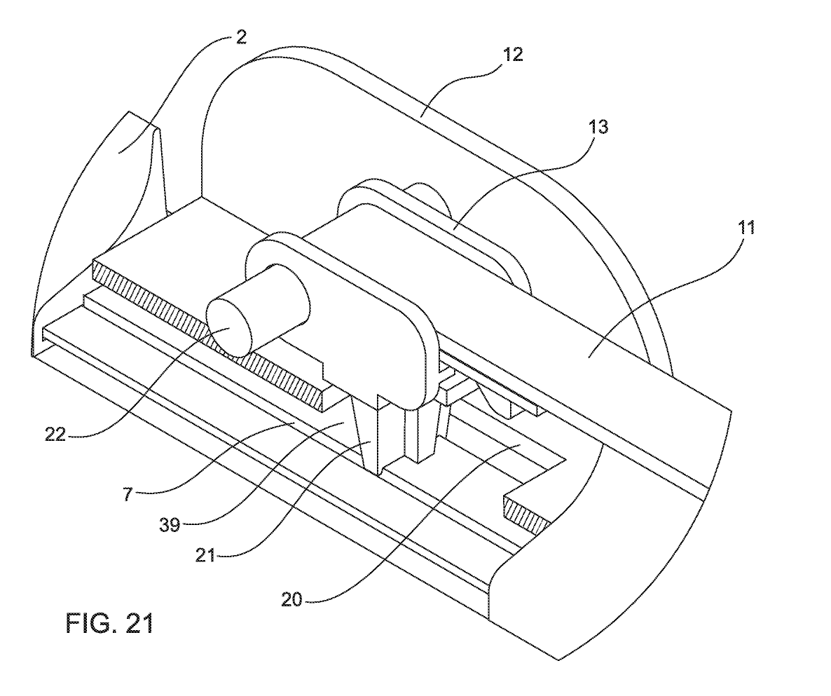

FIG. 21 is a detailed sectional view of the center block 12 and its various parts. This drawing demonstrates a center link stud 21 with a cross section somewhat resembling the shape of a cross. This cross section of the center link stud 21 is robust and will be resistant to damage, wear, and fatigue but it still reduces the surface area pressing on the wiper insert 7, thereby increasing the pressure and so wiper insert 7 material deformation and friction.

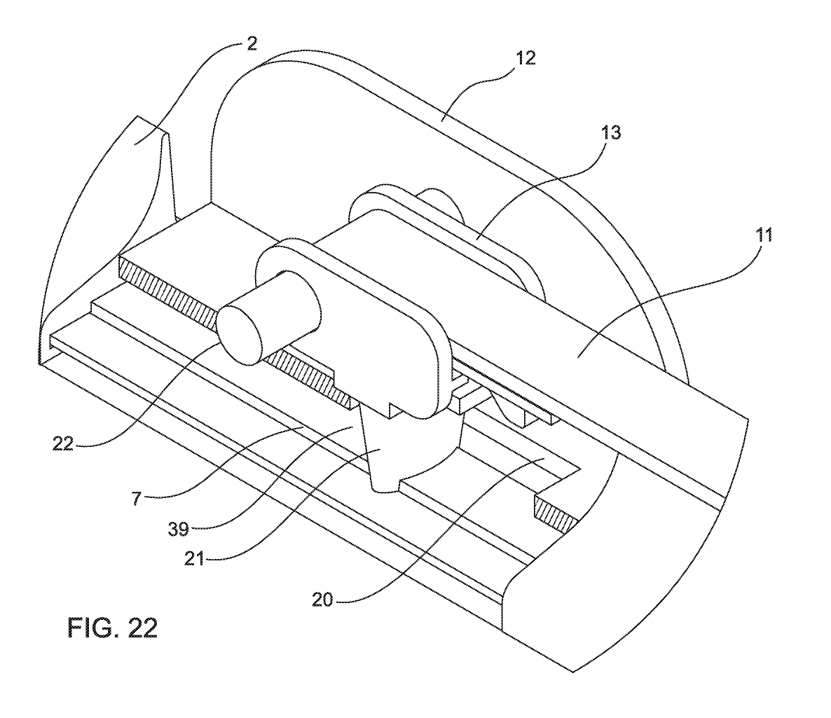

FIG. 22 illustrate the same embodiment of a center clock 22 shown in FIG. 21, but with the cross section of the center link stud 21 resembling an oval shape. The decreasing cross section can also be present. A person skilled in the art will appreciate that any profile of the center link stud 21 which provides the necessary pressure on the wiper insert 7 may be used with the presently disclosed center block 12.

FIG. 23 illustrates a sectional view of another embodiment of center block 12. FIG. 23 shows a center link stud 21 with a shape of a chisel. The center link stud 21 should not be tapered so greatly that the wiper insert 7 is cut when pressed against, or a user can't touch it and/or and get injured. The center link stud 21 is resistant to damage, wear and fatigue. The chisel shape of the center link stud 21 is very robust and will be resistant to damage, wear, and fatigue but it still reduces the surface area pressing on the wiper insert 7, thereby increasing the pressure and friction of the wiper insert 7.

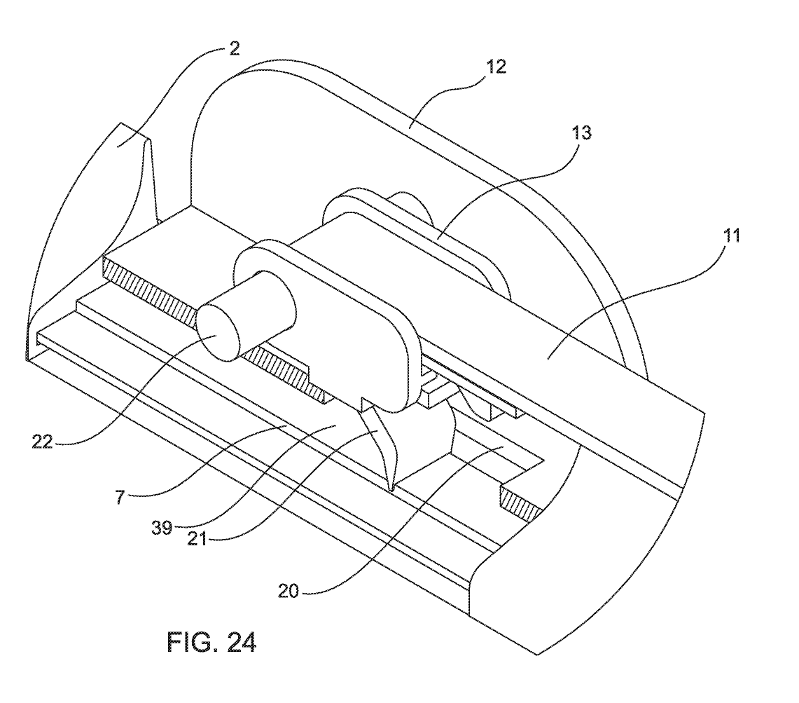

FIG. 24 depicts a sectional view of an embodiment of the center block 12. This drawing demonstrates a center link stud 21 with a shape somewhat of an angled chisel. The length and angle of the center link stud 21 allows a spring action of the center link stud 21, which will allow effective operation for various relative angles between the wiper arm 11 and the wiper blade 10 when installed on the vehicle windshield. This spring action of the center link stud 21 will compensate for minor differences in various vehicles which may cause angle differences between wiper arm 11, therefore the wiper insert 7 will not be unsecured when the wiper insert 7 it is intended to be secured, especially when driving. The center link stud 21 may decreases in cross section to allow for an effective spring action and a smaller pressing surface, but the decrease in cross section does not make the center link stud 21 less resistant to damage, wear, and fatigue. The Center Link Stud 21 can be made of various resilient materials, or combinations of them, including; thermoplastics with superior resistance to creep and fatigue, machined plastic with superior resistance to creep and fatigue, stainless steel, or aluminum.

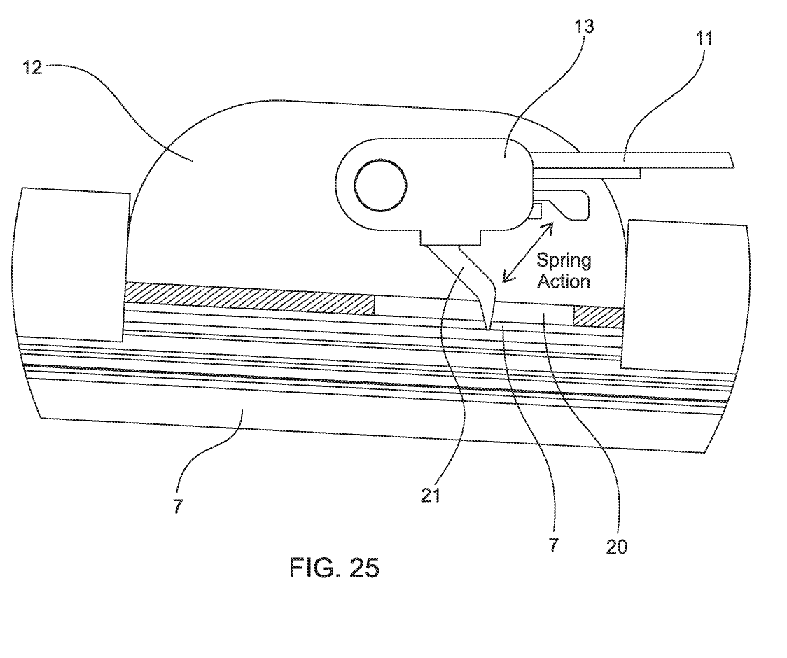

FIG. 25 is a sectional side view of the same embodiment of center block 12 shown FIG. 24, and shows a shape of the center link stud 21 that allows the spring action. The bidirectional arrow indicates the approximate directions the center link stud 21 will move relative to the center link 13 as the wiper blade 10 is set and removed from the vehicle windshield. As shown, the center link stud 21 is pressing into the back of the wiper insert 7.

Generally, to operate the center block 12 and open end cap 38 according to the embodiments illustrated in FIGS. 19 and 25 and described herein, one uses the wiper blade 10 in a normal manner, against the vehicle windshield. When the wiper blade 10 has degraded performance and the wiper insert 7 is found to be the cause, the wiper 7 insert can be replaced as follows. The user lifts the wiper blade 10 off of vehicle windshield and rotates the wiper blade 10 so the wiper insert 7 is now approximately up. During this rotation, the center link stud 21 stops pressing on the back of the wiper insert 7 and so the wiper insert 7 is now moveable longitudinally. The user then pulls of the wiper insert 7 out of the wiper blade 10 and installs a new wiper insert 7 into the wiper blade 10 so that the wiper insert 7 is approximately centered. Lastly, the user then turns the wiper blade 10 over and sets it against the vehicle windshield, in the wiper blades 1 regular operation position. During the turning process, the user can hold the wiper insert 7 in place. The user should verify the wiper insert 7 is correctly positioned in the wiper blade 10 when it is resting against the vehicles windshield.

In some embodiments, the presently disclosed subject matter provides a device which allows the user to change the curvature of the wiper blade 10 when its performance is unacceptable and wiper blade 10 curvature is found to be the cause.

No known wiper blade 10 allows curvature to be adjusted by the user. Curvature being the approximate radius the wiper blade 10 follows when not against the vehicle windshield. Greater curvature decreases in radius while a decreased curvature would be a flatter wiper blade 10 which has an increases wiper blade 10 radius. Also, wiper blade 10 generally performs adequately for some vehicle windshields but does not for others. The disparity in wiper blade 10 performance is largely due to variations in the curvature of the vehicle windshields and the wiper arm 11 force pressing the wiper blade 10 against the windshield, as well as the length of the wiper blade 10. Likewise, the wiper blade springs 6 will relax over time which leads to less curvature and so will apply less pressure at the ends of the wiper blade 10.

The presently disclosed device which allows the user to change the curvature of the wiper blade 10 is described below. Adjacent to one ends of the center block 12 is a first pillar 43 that secure to the springs 6. Adjacent to the other end of the center block 12 is a second pillar 44. The first pillar 43 and second pillar 44 can be separate components of the wiper blade 10 or can be elements of the center block 12. If the first pillar 43 and second pillar 44 are separate components, they can be secured to the springs 6 by various means, including an adhesive bond or cohesive bond or by crimping. If the first pillar 43 and second pillar 44 are elements of the center block 12, the first pillar 43 and second pillar 44 must be allowed to pivot relative to center block 12, which can be done by a pillar hinge 46 or flexible member 45 that joins the first pillar 43 and second pillar 44 to the center block 12, or the center block 12 can bend along its base and the first pillar 43 and second pillar 44 are adhered to the center block 12 or are elements of the center block 12. The first pillar 44 secures a screw 47 longitudinally by a screw retainer 48, which can be a retainer ring or other means and the first pillar hole 49 is not threaded. The second pillar 44 has a second pillar threaded hole 50 or a pivot nut 51 secured to the second pillar 44. From the first pillar 43 protrudes the screw 47 that engages the second pillar threaded hole 50 or the pivot nut 51. The screw head 52 of the screw 47 may have one or more screw head lever arm(s) 53 which can resemble a winged screw. With the wiper blade 10 at normal curvature, the screw 47 can be approximately at its midpoint in the second pillar threaded hole 50. The screw thread 52 has latching protrusions 54 so that the screw 47 will not move during normal use. This latching action can be accomplished in many ways, including latching cavities 56 in the first pillar 43 and complementary latching protrusions 54 on the screw head 47 or screw shaft 55 or by using the screw head lever arm 53 as a latching protrusion 54 and with both the latching cavities 56 and the latching protrusions 54 being equally spaced by a factor of 360° i.e. 180° or 120° or 90° and so on. Another means of causing the screw 47 to not rotate while in normal use is the screw head lever arm 53 of the screw 47 engages with a latching cavity 56 on the first pillar 43 or the center block 12.

Another embodiment would have the springs 6 at a natural curvature beyond any vehicle needed for any vehicle windshield, meaning the wiper blade 10 is has too much curvature without this device. The device would serve to decrease the curvature from the natural state, which is when the device is not installed and the wiper blade 10 is not installed on the vehicles windshield. Such an embodiment could have a first pillars 43 and a second pillar 44, one on either side of the center block 12. Which first pillar 43 and second pillar 44 are fixed to the springs 6. Between the first pillar 43 and second pillar 44 is a tether 57 that can pull the first pillar 43 and second pillar 44 closer together, which when the tether 57 length is decreased there will also be a decrease in the curvature of the wiper blade 10. The tether 57 could be similar to a zip tie, which has latching cavities 56 that interact with latching protrusion 54 and so the tether 57 will have incremental lengths. Said latching protrusion 54 could be part of the first pillar 43 or the second pillar 44. Such a tether 57 could be a protrusion from the first pillar 43 and the tether 57 then travels through a pillar tether hole 58 in the second pillar 44. The pillar tether hole 58 being a through hole element of the first pillar 43 or the second pillar 44. Alternatively, the tether 57 can be a protrusion from the second pillar 44 and be directed towards the pillar tether hole 58, which is then an element of the first pillar 43. The pillar tether hole 58 has one or more latching protrusion(s) 54 that engages with the latching cavities 56 of the tether 57 to latch it at various lengths. The latching protrusion 56 can be manipulated by the user to unlatch, so the length of the tether 57 can be repeatedly adjusted until optimal, meaning the length of the tether 57 between the first pillar 43 and the second pillar 44 can be decreased as well as increased. When the device is installed as part of the wiper blade 10, the tether 57 extends beyond the pillar tether hole 58.

The screw 47 and first pillar 43 and second pillar 44 and any elements of either should resist bending or deformation and could be made of various materials including thermoplastics, metals, and carbon fiber. A tether 57 can be made of material that is resistant to sunlight damage, may be able to bend, and can withstand tension and so could be made of various materials including thermoplastics, nylon, metal that is comparatively thin, and carbon fiber.

A similar embodiment has a cam cleat 59 as an element of the pillar tether hole 58. The cam cleat 59 has one or two movable cleat members 60 that are in contact with the tether 57. When the tether 57 is under increasing tension, the cleat members 60 increasingly engage with the tether 57 thereby securing the tether 57. A cleat member lever 61 is a protrusion from the cleat member 60 that when pressed by the user, will cause the cleat member(s) 60 to disengage from the tether 57 which allows the tether 57 length between the first pillar 43 and the second pillar 44 to increase which causes an increase the curvature of the wiper blade 10.

Generally, to operate the device which allows the user to change the curvature of the wiper blade 10 according to the embodiments described herein, one uses the wiper blade 10 in a normal manner, against the vehicle windshield. When the wiper blade 10 has degraded performance and the curvature of the wiper blade 10 is found to be the cause of poor performance, the wiper blade 10 curvature can be changed as follows. The degraded performance can be found at first install or after long use. The user observes the operation of the wiper blade 10. If one or both of the ends of the wiper blade 10 are not making contact then the curvature of the wiper blade 10 needs to be increased. If part of the center of the wiper blade 10 is not making contact, then curvature of the wiper blade 10 needs to be decreased. To increase the curvature, the screw 47 is turned so that the first pillar 43 and second pillar 44 are pressed apart. To decrease the curvature of the wiper blade 10, the screw 47 is turned to pull the first pillar 43 and second pillar 44 together. The user retests the wiper blades 10 and adjusts the wiper blade 10 curvature until performance is optimized.

Alternatively, if the device has a tether 57 and does not have a screw 47, then to increase the curvature of the wiper blade 10, the latching protrusions 54 are removed from the latching cavities 56 until the curvature is increased until optimized, then the latching protrusions 54 are again returned to latching cavities 56. If the curvature needs to be decreased, the tether 57 is pulled.

Alternatively, if the device has a tether 57 and a cam cleat 59, then to increase the curvature of the wiper blade 10, the cleat member lever 61 is pressed by the user. To decrease the curvature of the wiper blade 10 the tether 57 is pulled through the pillar tether hole 58 and associated cam cleat 59.

That which is claimed:

1. A wiper blade end cap for securing a wiper insert comprising:
an end cap housing attachable to the wiper blade
and a gate attachable to said end cap housing, wherein the gate can be in at least a closed and open position: and,
wherein said gate in a closed position blocks the longitudinal movement of the wiper insert, and said gate in an open position facilitate the removal and replacement of a wiper insert.

2. The end cap according to claim 1, wherein the gate is attached to the end cap housing by a hinge.

3. The end cap according to claim 2, wherein the hinge is located at the front and distal end of the end cap housing and is oriented so that the hinge axis is vertical and gate latching is caused by the interaction of a gate latch at the end of the side of the gate and a complementary latch edge on the back of the end cap housing.

4. The end cap according to claim 3, wherein the type of hinge is selected from a group comprising of the living hinge type, the snap fit type and pin joint.

5. The end cap according to claim 4, wherein part or all of the hinge is coated with a protective coating.

6. End cap according to claim 4, where the hinge is of the living hinge type, and wherein a hinge bulwark serves to increase the radius of the hinge when the gate is in the closed position.

7. The end cap according to claim 4, wherein the gate latch has an acute latch edge angle and the latch edge has a complementary angle.

8. The end cap according to claim 5, wherein the coating is applied when the gate is between the closed position and open position of the gate.

9. The end cap according to claim 1, wherein the gate is made of elastic material.

10. The end cap according to claim 9, wherein the elastic material comprises UV inhibitors.

11. The end cap according to claim 10, wherein gate is adhered to the end cap housing.

12. A device for securing a wiper insert comprising:
a cutout and a center link stud, wherein said stud is attachable to a wiper blade; and, at least one open end cap.

13. The device of claim 12, wherein the cutout is in the center block.

14. The device of claim 12, wherein the center link stud can be in a position wherein said stud projects through the cutout and presses against the wiper insert or in a position wherein said stud does not press against the wiper insert.

15. The device according to claim 13, wherein the center link stud is an element of the wiper arm link.

16. The device according to claim 14, wherein the center link stud decreases in cross section distally from the wiper arm.

17. The device according to claim 14 wherein the center link stud is angled relative to the wiper blade to provide a springing action relative to the wiper insert.

18. The device according to claim 12, wherein the center link stud is an element of a component selected from a group comprising the open end cap, end cap, standard end cap, wind deflector or center block, and said center link stud latches when pressing against the wiper insert.

19. The device according to claim 14, wherein the wiper insert can be removed or replaced through the open end cap when the center link stud is in a position wherein said stud does not press against the wiper insert.
